(19) United States
(12) Patent Application Publication
(10) Pub. No.: US 2004/0093336 A1
(43) Pub. Date: May 13, 2004

(54) Computer program method and apparatus to recognize and normalize data pattern based information

(76) Inventors: Jinsong Hu, San Jose, CA (US); Supreet Oberoi, Redwood Shores, CA (US); Tzu-Chaing Yuan, San Francisco, CA (US); Huasheng Su, Fremont, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/431,302

(22) Filed: May 6, 2003

Related U.S. Application Data
(60) Provisional application No. 60/378,414, filed on May 6, 2002.

(51) Int. Cl. G06F 17/00

(52) U.S. Cl. 707/100

(57) ABSTRACT

A method of recognizing and normalizing repeatable data pattern from a file uses a computer executing a computer program. The file is first received by the computer program. The data pattern of the file is recognized based upon a profile selected from a plurality of profiles from a library. The file is parsed into a plurality of data fields based upon the profile selected. The data from the file is stored in a database.

### TECHNICAL FIELD

This application claims the benefit of U.S. Provisional Application No. 60/378,414, filed on May 6, 2002, entitled “An Automated System for Recognizing and Normalizing Pattern Based Information”, whose disclosure is incorporated herein by reference.

The present invention relates to a method, system and article of manufacture for a computer program to recognize and normalize repeatable data pattern from a file, and more particularly wherein said method and apparatus can recognize and normalize the repeatable data patter automatically, with provision for increasing the accuracy of such recognition as usage increases.

This application incorporates by reference the files on a computer program listing appendix which is on a Compact Disc Recordable (CD-R) media, (of which two identical copies are submitted) each for operating under IBM-PC machine format and MS-Windows operating system. The files are for execution by any machine supporting a Java Virtual Machine (JVM) and are thus platform independent. The list of files contained on the CD-R media, including the names, sizes in bytes and dates of creation is as follows:

| | | |
|---|---|---|
| DATE | SIZE | FILE NAMES |

Directory of com\agile\sandbox\pi

| | | |
|---|---|---|
| 05/06/2002 10:23a | <DIR> | . |
| 05/06/2002 10:23a | <DIR> | .. |
| 05/06/2002 10:22a | <DIR> | admin |
| 05/06/2002 10:23a | <DIR> | database |
| 05/06/2002 10:23a | <DIR> | fma |
| 05/06/2002 10:23a | <DIR> | logger |
| 05/06/2002 10:23a | <DIR> | notification |
| 05/06/2002 10:23a | <DIR> | pm |
| 05/06/2002 10:23a | <DIR> | qa |

| | |
|---|---|
| 0 File(s) | 0 bytes |

Directory of com\agile\sandbox\pi\admin

| | | |
|---|---|---|
| 05/06/2002 10:22a | <DIR> | . |
| 05/06/2002 10:22a | <DIR> | .. |
| 05/06/2002 10:21a | <DIR> | cm |
| 05/06/2002 10:22a | <DIR> | eventhandlers |
| 05/06/2002 10:22a | <DIR> | events |
| 05/06/2002 10:22a | <DIR> | gui |
| 05/06/2002 10:22a | <DIR> | model |
| 05/06/2002 10:22a | <DIR> | reports |
| 05/06/2002 10:22a | <DIR> | tests |
| 05/06/2002 10:22a | <DIR> | util |
| 05/06/2002 10:22a | <DIR> | view |

| | |
|---|---|
| 0 File(s) | 0 bytes |

Directory of com\agile\sandbox\pi\admin\cm

| | | |
|---|---|---|
| 05/06/2002 10:21a | <DIR> | . |
| 05/06/2002 10:21a | <DIR> | .. |
| 05/06/2002 10:21a | <DIR> | eventhandlers |
| 05/06/2002 10:21a | <DIR> | events |
| 05/06/2002 10:21a | <DIR> | model |
| 05/06/2002 10:21a | <DIR> | translator |
| 05/06/2002 10:21a | <DIR> | util |
| 05/06/2002 10:21a | <DIR> | view |

| | |
|---|---|
| 0 File(s) | 0 bytes |

Directory of com\agile\sandbox\pi\admin\cm\eventhandlers

| | | |
|---|---|---|
| 05/06/2002 10:21a | <DIR> | . |
| 05/06/2002 10:21a | <DIR> | .. |
| 05/06/2002 10:21a | 5,232 | AgileExportEH.java |
| 05/06/2002 10:21a | 2,389 | AgileFieldsMapEH.java |
| 05/06/2002 10:21a | 1,709 | AgileImportEH.java |
| 05/06/2002 10:21a | 5,124 | AgileValidateProcessEH.java |
| 05/06/2002 10:21a | 3,108 | BomAmlDataEditAIIEH.java |
| 05/06/2002 10:21a | 3,788 | BomAmlDataEditEH.java |
| 05/06/2002 10:21a | 2,564 | CMParameterEH.java |
| 05/06/2002 10:21a | 3,065 | CmProfileEH.java |
| 05/06/2002 10:21a | 2,637 | CMProfileSearchEH.java |
| 05/06/2002 10:21a | 7,682 | CollectCMBomEH.java |
| 05/06/2002 10:21a | 3,098 | DataSourceEH.java |
| 05/06/2002 10:21a | 3,530 | EditCMModuleMapEH.java |
| 05/06/2002 10:21a | 3,365 | EditCMParameterEH.java |
| 05/06/2002 10:21a | 3,897 | EditPartyAliasEH.java |
| 05/06/2002 10:21a | 4,220 | MatchingProfileEH.java |
| 05/06/2002 10:21a | 2,314 | MPNMatchEditEH.java |
| 05/06/2002 10:21a | 3,959 | MPNMatchEH.java |
| 05/06/2002 10:21a | 3,529 | MPNMatchResultEH.java |
| 05/06/2002 10:21a | 1,574 | PartMatchingEH.java |
| 05/06/2002 10:21a | 3,832 | PartyAliasEH.java |
| 05/06/2002 10:21a | 3,351 | TranslateEH.java |

| | |
|---|---|
| 21 File(s) | 73,967 bytes |

Directory of com\agile\sandbox\pi\admin\cm\events

| | | |
|---|---|---|
| 05/06/2002 10:21a | <DIR> | . |
| 05/06/2002 10:21a | <DIR> | .. |
| 05/06/2002 10:21a | 1,282 | AgileExportEvent.java |
| 05/06/2002 10:21a | 2,165 | AgileFieldsMapEvent.java |
| 05/06/2002 10:21a | 3,336 | AgileImportEvent.java |
| 05/06/2002 10:21a | 7,746 | AgileValidateProcessEvent.java |
| 05/06/2002 10:21a | 6,750 | BomAmlDataEditAllEvent.java |
| 05/06/2002 10:21a | 10,707 | BomAmlDataEditEvent.java |
| 05/06/2002 10:21a | 3,029 | CMParameterEvent.java |
| 05/06/2002 10:21a | 6,254 | CmProfileEvent.java |
| 05/06/2002 10:21a | 2,607 | CMProfileSearchEvent.java |
| 05/06/2002 10:21a | 14,984 | CollectCMBomEvent.java |
| 05/06/2002 10:21a | 8,646 | DataSourceEvent.java |
| 05/06/2002 10:21a | 2,252 | EditCMModuleMapEvent.java |
| 05/06/2002 10:21a | 2,250 | EditCMParameterEvent.java |
| 05/06/2002 10:21a | 4,808 | EditPartyAliasEvent.java |
| 05/06/2002 10:21a | 3,774 | MatchingProfileEvent.java |
| 05/06/2002 10:21a | 6,769 | MPNMatchEditEvent.java |
| 05/06/2002 10:21a | 19,079 | MPNMatchEvent.java |
| 05/06/2002 10:21a | 11,058 | MPNMatchResultEvent.java |
| 05/06/2002 10:21a | 2,765 | PartMatchingEvent.java |
| 05/06/2002 10:21a | 4,529 | PartyAliasEvent.java |
| 05/06/2002 10:21a | 7,358 | TranslateEvent.java |

| | |
|---|---|
| 21 File(s) | 132,148 bytes |

Directory of com\agile\sandbox\pi\admin\cm\model

| | | |
|---|---|---|
| 05/06/2002 10:21a | <DIR> | . |
| 05/06/2002 10:21a | <DIR> | .. |
| 05/06/2002 10:21a | 1,988 | AgileExportInfo.java |
| 05/06/2002 10:21a | 1,753 | AgileExportResults.java |
| 05/06/2002 10:21a | 19,898 | AgileFieldsMapModel.java |
| 05/06/2002 10:21a | 6,497 | AgileImportModel.java |
| 05/06/2002 10:21a | 15,896 | AgileValidateProcessModel.java |
| 05/06/2002 10:21a | 7,790 | BomAmlDataEditAllModel.java |
| 05/06/2002 10:21a | 41,282 | BomAmlDataEditModel.java |
| 05/06/2002 10:21a | 13,466 | CMParameterModel.java |
| 05/06/2002 10:21a | 28,100 | CmProfileModel.java |
| 05/06/2002 10:21a | 15,794 | CMProfileSearchModel.java |
| 05/06/2002 10:21a | 27,510 | DataSourceModel.java |
| 05/06/2002 10:21a | 14,349 | EditCMModuleMapModel.java |
| 05/06/2002 10:21a | 10,641 | EditCMParameterModel.java |
| 05/06/2002 10:21a | 12,294 | EditPartyAliasModel.java |
| 05/06/2002 10:21a | 6,219 | MatchingProfileModel.java |
| 05/06/2002 10:21a | 10,708 | MPNMatchEditModel.java |
| 05/06/2002 10:21a | 27,856 | MPNMatchModel.java |
| 05/06/2002 10:21a | 45,900 | MPNMatchResultModel.java |
| 05/06/2002 10:21a | 6,379 | ParseProcess.java |
| 05/06/2002 10:21a | 41,646 | ParseValidateProcess.java |
| 05/06/2002 10:21a | 5,110 | PartMatchingModel.java |
| 05/06/2002 10:21a | 19,970 | PartyAliasModel.java |
| 05/06/2002 10:21a | 13,092 | TranslateModel.java |

| | |
|---|---|
| 23 File(s) | 394,138 bytes |

Directory of com\agile\sandbox\pi\admin\cm\translator

| | | |
|---|---|---|
| 05/06/2002 10:21a | <DIR> | . |
| 05/06/2002 10:21a | <DIR> | .. |
| 05/06/2002 10:21a | 9,343 | Translator.java |

| | |
|---|---|
| 1 File(s) | 9,343 bytes |

Directory of com\agile\sandbox\pi\admin\cm\util

| | | |
|---|---|---|
| 05/06/2002 10:21a | <DIR> | . |
| 05/06/2002 10:21a | <DIR> | .. |
| 05/06/2002 10:21a | 21,571 | BomRecord.java |
| 05/06/2002 10:21a | 51,569 | CMUtil.java |
| 05/06/2002 10:21a | 1,517 | TranslatePmObjectCopier.java |
| 05/06/2002 10:21a | 3,637 | UtilHSSFBuilder.java |
| 05/06/2002 10:21a | 159,182 | ValidatedBom.java |

| | |
|---|---|
| 5 File(s) | 237,476 bytes |

Directory of com\agile\sandbox\pi\admin\cm\view

| | | |
|---|---|---|
| 05/06/2002 10:21a | <DIR> | . |
| 05/06/2002 10:21a | <DIR> | .. |
| 05/06/2002 10:21a | <DIR> | web |

| | |
|---|---|
| 0 File(s) | 0 bytes |

Directory of com\agile\sandbox\pi\admin\cm\view\web

| | | |
|---|---|---|
| 05/06/2002 10:21a | <DIR> | . |
| 05/06/2002 10:21a | <DIR> | .. |
| 05/06/2002 10:21a | <DIR> | handler |

| | |
|---|---|
| 0 File(s) | 0 bytes |

Directory of com\agile\sandbox\pi\admin\cm\view\web\handler

| | | |
|---|---|---|
| 05/06/2002 10:21a | <DIR> | . |
| 05/06/2002 10:21a | <DIR> | .. |
| 05/06/2002 10:21a | 4,283 | CMRequestHandler.java |

| | |
|---|---|
| 1 File(s) | 4,283 bytes |

Directory of com\agile\sandbox\pi\admin\eventhandlers

| | | |
|---|---|---|
| 05/06/2002 10:22a | <DIR> | . |
| 05/06/2002 10:22a | <DIR> | .. |
| 05/06/2002 10:21a | 5,353 | AssignRelationshipEH.java |
| 05/06/2002 10:21a | 2,370 | BICReportEH.java |
| 05/06/2002 10:21a | 3,774 | CreateDashboardEH.java |
| 05/06/2002 10:21a | 2,662 | CreateFilterEH.java |
| 05/06/2002 10:21a | 3,298 | CreateMappingLookupEH.java |
| 05/06/2002 10:21a | 2,787 | CreateNodeCommandEH.java |
| 05/06/2002 10:21a | 2,526 | CreateNodeViewEH.java |
| 05/06/2002 10:21a | 2,739 | CreatePermissionEH.java |
| 05/06/2002 10:21a | 2,624 | CreateRoleEH.java |
| 05/06/2002 10:21a | 3,623 | CreateServicesSubscriptionEH.java |
| 05/06/2002 10:22a | 2,501 | CreateSupplierAliasEH.java |
| 05/06/2002 10:21a | 3,071 | CreateTailoredViewEH.java |
| 05/06/2002 10:21a | 7,421 | CreateTemplateEH.java |
| 05/06/2002 10:21a | 2,601 | DashboardSearchEH.java |
| 05/06/2002 10:21a | 3,940 | EditParserProfileEH.java |
| 05/06/2002 10:21a | 2,671 | EditTailoredViewEH.java |
| 05/06/2002 10:21a | 2,897 | ExceptionClassProfileEH.java |
| 05/06/2002 10:21a | 2,490 | FileTypeConversionEH.java |
| 05/06/2002 10:21a | 2,886 | FilterSearchEH.java |
| 05/06/2002 10:21a | 3,029 | MaintainParserProfileEH.java |
| 05/06/2002 10:21a | 2,825 | MapPermissionsEH.java |
| 05/06/2002 10:21a | 3,033 | MappingLookupSearchEH.java |
| 05/06/2002 10:21a | 2,354 | MapRolesEH.java |
| 05/06/2002 10:21a | 3,440 | MergeTestEH.java |
| 05/06/2002 10:21a | 2,978 | NodeCommandSearchEH.java |
| 05/06/2002 10:21a | 2,979 | NodeViewSearchEH.java |
| 05/06/2002 10:21a | 4,189 | OrganizationEH.java |
| 05/06/2002 10:21a | 3,708 | OrganizationSearchEH.java |
| 05/06/2002 10:21a | 3,509 | ParseBomAmlEH.java |
| 05/06/2002 10:21a | 8,847 | ParserProfileEH.java |
| 05/06/2002 10:21a | 3,287 | ParserProfileSearchEH.java |
| 05/06/2002 10:21a | 2,571 | ParserRecognitionTestEH.java |
| 05/06/2002 10:21a | 3,417 | ParseTestEH.java |
| 05/06/2002 10:21a | 2,749 | PartyRelationshipEH.java |
| 05/06/2002 10:22a | 3,185 | PartyRelationshipSearchEH.java |
| 05/06/2002 10:22a | 2,622 | PermissionSearchEH.java |
| 05/06/2002 10:22a | 3,745 | RecordMaintenanceEH.java |
| 05/06/2002 10:22a | 2,918 | RegularExpressionTestEH.java |
| 05/06/2002 10:22a | 2,393 | RemoveTestEH.java |
| 05/06/2002 10:22a | 2,505 | RoleSearchEH.java |
| 05/06/2002 10:22a | 2,704 | SearchTailoredViewEH.java |
| 05/06/2002 10:22a | 2,581 | SearchUserTypeEH.java |
| 05/06/2002 10:22a | 2,832 | ServicesSubscriptionSearchEH.java |
| 05/06/2002 10:22a | 2,494 | SupplierAliasMergeEH.java |
| 05/06/2002 10:22a | 2,949 | SupplierAliasSearchEH.java |
| 05/06/2002 10:22a | 3,288 | TemplateControlEH.java |
| 05/06/2002 10:22a | 2,697 | TemplateOptionEH.java |
| 05/06/2002 10:22a | 3,252 | TemplateSearchEH.java |
| 05/06/2002 10:22a | 2,003 | UserEH.java |
| 05/06/2002 10:22a | 2,957 | UserSearchEH.java |
| 05/06/2002 10:22a | 2,707 | UserTypeEH.java |
| 05/06/2002 10:22a | 2,278 | ViewSampleBomFileEH.java |

| | |
|---|---|
| 52 File(s) | 165,259 bytes |

Directory of com\agile\sandbox\pi\admin\events

| | | |
|---|---|---|
| 05/06/2002 10:22a | <DIR> | . |
| 05/06/2002 10:22a | <DIR> | .. |
| 05/06/2002 10:22a | 3,253 | AssignRelationshipEvent.java |
| 05/06/2002 10:22a | 2,626 | BICReportEvent.java |
| 05/06/2002 10:22a | 7,671 | CreateDashboardEvent.java |
| 05/06/2002 10:22a | 3,141 | CreateFilterEvent.java |
| 05/06/2002 10:22a | 7,433 | CreateMappingLookupEvent.java |
| 05/06/2002 10:22a | 5,053 | CreateNodeCommandEvent.java |
| 05/06/2002 10:22a | 3,965 | CreateNodeViewEvent.java |
| 05/06/2002 10:22a | 5,058 | CreatePermissionEvent.java |
| 05/06/2002 10:22a | 4,687 | CreateRoleEvent.java |
| 05/06/2002 10:22a | 5,496 | CreateServicesSubscriptionEvent.java |
| 05/06/2002 10:22a | 1,752 | CreateSupplierAliasEvent.java |
| 05/06/2002 10:22a | 4,798 | CreateTailoredViewEvent.java |
| 05/06/2002 10:22a | 11,043 | CreateTemplateEvent.java |
| 05/06/2002 10:22a | 2,188 | DashboardSearchEvent.java |
| 05/06/2002 10:22a | 2,571 | EditParserProfileEvent.java |
| 05/06/2002 10:22a | 3,313 | EditTailoredViewEvent.java |
| 05/06/2002 10:22a | 2,721 | ExceptionClassProfileEvent.java |
| 05/06/2002 10:22a | 6,131 | FileTypeConversionEvent.java |
| 05/06/2002 10:22a | 2,384 | FilterSearchEvent.java |
| 05/06/2002 10:22a | 5,457 | MaintainParserProfileEvent.java |
| 05/06/2002 10:22a | 2,628 | MapPermissionsEvent.java |
| 05/06/2002 10:22a | 2,489 | MappingLookupSearchEvent.java |
| 05/06/2002 10:22a | 3,370 | MapRolesEvent.java |
| 05/06/2002 10:22a | 5,504 | MergeTestEvent.java |
| 05/06/2002 10:22a | 2,392 | NodeCommandSearchEvent.java |
| 05/06/2002 10:22a | 2,414 | NodeViewSearchEvent.java |
| 05/06/2002 10:22a | 14,115 | OrganizationEvent.java |
| 05/06/2002 10:22a | 8,590 | OrganizationSearchEvent.java |
| 05/06/2002 10:22a | 14,814 | ParseBomAmlEvent.java |
| 05/06/2002 10:22a | 28,419 | ParserProfileEvent.java |
| 05/06/2002 10:22a | 2,901 | ParserProfileSearchEvent.java |
| 05/06/2002 10:22a | 3,802 | ParserRecognitionTestEvent.java |
| 05/06/2002 10:22a | 12,682 | ParseTestEvent.java |
| 05/06/2002 10:22a | 3,888 | PartyRelationshipEvent.java |
| 05/06/2002 10:22a | 3,556 | PartyRelationshipSearchEvent.java |
| 05/06/2002 10:22a | 2,203 | PermissionSearchEvent.java |
| 05/06/2002 10:22a | 3,979 | RecordMaintenanceEvent.java |
| 05/06/2002 10:22a | 3,957 | RegularExpressionTestEvent.java |
| 05/06/2002 10:22a | 2,789 | RemoveTestEvent.java |
| 05/06/2002 10:22a | 2,114 | RoleSearchEvent.java |
| 05/06/2002 10:22a | 2,522 | SearchTailoredViewEvent.java |
| 05/06/2002 10:22a | 2,232 | SearchUserTypeEvent.java |
| 05/06/2002 10:22a | 2,289 | ServicesSubscriptionSearchEvent.java |
| 05/06/2002 10:22a | 1,858 | SupplierAliasMergeEvent.java |
| 05/06/2002 10:22a | 2,008 | SupplierAliasSearchEvent.java |
| 05/06/2002 10:22a | 4,824 | TemplateControlEvent.java |
| 05/06/2002 10:22a | 2,814 | TemplateOptionEvent.java |
| 05/06/2002 10:22a | 2,780 | TemplateSearchEvent.java |
| 05/06/2002 10:22a | 18,398 | UserEvent.java |
| 05/06/2002 10:22a | 5,236 | UserSearchEvent.java |
| 05/06/2002 10:22a | 3,060 | UserTypeEvent.jaya |
| 05/06/2002 10:22a | 2,934 | ViewSampleBomFileEvent.java |

| | |
|---|---|
| 52 File(s) | 268,302 bytes |

Directory of com\agile\sandbox\pi\admin\gui

| | | |
|---|---|---|
| 05/06/2002 10:22a | <DIR> | . |
| 05/06/2002 10:22a | <DIR> | .. |
| 05/06/2002 10:22a | 2,032 | ParserConfiguration.java |

| | |
|---|---|
| 1 File(s) | 2,032 bytes |

Directory of com\agile\sandbox\pi\admin\model

| | | |
|---|---|---|
| 05/06/2002 10:22a | <DIR> | . |
| 05/06/2002 10:22a | <DIR> | .. |
| 05/06/2002 10:22a | 55,145 | AccessUnifyAdminDetails.java |
| 05/06/2002 10:22a | 25,793 | AssignRelationshipModel.java |
| 05/06/2002 10:22a | 7,974 | BICReportModel.java |
| 05/06/2002 10:22a | 45,694 | CreateDashboardModel.java |
| 05/06/2002 10:22a | 9,374 | CreateFilterModel.java |
| 05/06/2002 10:22a | 14,787 | CreateMappingLookupModel.java |
| 05/06/2002 10:22a | 19,508 | CreateNodeCommandModel.java |
| 05/06/2002 10:22a | 25,092 | CreateNodeViewModel.java |
| 05/06/2002 10:22a | 15,064 | CreatePermissionModel.java |
| 05/06/2002 10:22a | 16,985 | CreateRoleModel.java |
| 05/06/2002 10:22a | 57,977 | CreateServicesSubscriptionModel.java |
| 05/06/2002 10:22a | 6,939 | CreateSupplierAliasModel.java |
| 05/06/2002 10:22a | 26,383 | CreateTailoredViewModel.java |
| 05/06/2002 10:22a | 66,840 | CreateTemplateModel.java |
| 05/06/2002 10:22a | 10,345 | DashboardSearchModel.java |
| 05/06/2002 10:22a | 30,745 | EditParserProfileModel.java |
| 05/06/2002 10:22a | 22,820 | EditTailoredViewModel.java |
| 05/06/2002 10:22a | 14,132 | ExceptionClassesModel.java |
| 05/06/2002 10:22a | 17,870 | ExceptionClassProfileModel.java |
| 05/06/2002 10:22a | 11,991 | FileTypeConversionModel.java |
| 05/06/2002 10:22a | 12,019 | FilterSearchModel.java |
| 05/06/2002 10:22a | 2,795 | LoadTemplate.java |
| 05/06/2002 10:22a | 11,190 | MaintainParserProfileModel.java |
| 05/06/2002 10:22a | 21,983 | MapPermissionsModel.java |
| 05/06/2002 10:22a | 12,527 | MappingLookupSearchModel.java |
| 05/06/2002 10:22a | 33,696 | MapRolesModel.java |
| 05/06/2002 10:22a | 13,350 | MergeTestModel.java |
| 05/06/2002 10:22a | 22,470 | NodeCommandSearchModel.java |
| 05/06/2002 10:22a | 17,861 | NodeViewSearchModel.java |
| 05/06/2002 10:22a | 35,568 | OrganizationModel.java |
| 05/06/2002 10:22a | 34,229 | OrganizationSearchModel.java |
| 05/06/2002 10:22a | 25,135 | ParseBomAmlModel.java |
| 05/06/2002 10:22a | 10,835 | ParserLinePatternsModel.java |
| 05/06/2002 10:22a | 14,367 | ParserNameClassModel.java |
| 05/06/2002 10:22a | 8,378 | ParserProfileCustomModel.java |
| 05/06/2002 10:22a | 15,064 | ParserProfileDetailsModel.java |
| 05/06/2002 10:22a | 27,604 | ParserProfileExport.java |
| 05/06/2002 10:22a | 29,918 | ParserProfileImport.java |
| 05/06/2002 10:22a | 35,248 | ParserProfileModel.java |
| 05/06/2002 10:22a | 34,531 | ParserProfileSearchModel.java |
| 05/06/2002 10:22a | 10,155 | ParserRecognitionTestModel.java |
| 05/06/2002 10:22a | 27,337 | ParserTables.java |
| 05/06/2002 10:22a | 21,697 | ParseTestModel.java |
| 05/06/2002 10:22a | 18,519 | PartyRelationshipModel.java |
| 05/06/2002 10:22a | 35,359 | PartyRelationshipSearchModel.java |
| 05/06/2002 10:22a | 11,799 | PermissionSearchModel.java |
| 05/06/2002 10:22a | 17,345 | RecordMaintenanceModel.java |
| 05/06/2002 10:22a | 5,097 | RegularExpressionTestModel.java |
| 05/06/2002 10:22a | 5,609 | RemoveTestModel.java |
| 05/06/2002 10:22a | 19,710 | RoleSearchModel.java |
| 05/06/2002 10:22a | 9,789 | SampleBomFileAttachModel.java |
| 05/06/2002 10:22a | 16,756 | SearchTailoredViewModel.java |
| 05/06/2002 10:22a | 11,873 | SearchUserTypeModel.java |
| 05/06/2002 10:22a | 18,196 | ServicesSubscriptionSearchModel.java |
| 05/06/2002 10:22a | 6,469 | SupplierAliasMergeModel.java |
| 05/06/2002 10:22a | 12,915 | SupplierAliasSearchModel.java |
| 05/06/2002 10:22a | 2,291 | TemplateControl.java |
| 05/06/2002 10:22a | 25,855 | TemplateControlModel.java |
| 05/06/2002 10:22a | 2,587 | TemplateOption.java |
| 05/06/2002 10:22a | 13,627 | TemplateOptionModel.java |
| 05/06/2002 10:22a | 17,741 | TemplateSearchModel.java |
| 05/06/2002 10:22a | 65,529 | UserModel.java |
| 05/06/2002 10:22a | 32,169 | UserSearchModel.java |
| 05/06/2002 10:22a | 21,038 | UserTypeModel.java |
| 05/06/2002 10:22a | 4,470 | ViewSampleBomFileModel.java |

| | |
|---|---|
| 65 File(s) | 1,354,158 bytes |

Directory of com\agile\sandbox\pi\admin\reports

| | | |
|---|---|---|
| 05/06/2002 10:22a | <DIR> | . |
| 05/06/2002 10:22a | <DIR> | .. |
| 05/06/2002 10:22a | 7,716 | BICReport.java |

| | |
|---|---|
| 1 File(s) | 7,716 bytes |

Directory of com\agile\sandbox\pi\admin\tests

| | | |
|---|---|---|
| 05/06/2002 10:22a | <DIR> | . |
| 05/06/2002 10:22a | <DIR> | .. |
| 05/06/2002 10:22a | 2,044 | BomRecordTest.java |
| 05/06/2002 10:22a | 1,993 | TranslateTest.java |

| | |
|---|---|
| 2 File(s) | 4,037 bytes |

Directory of com\agile\sandbox\pi\admin\util

| | | |
|---|---|---|
| 05/06/2002 10:22a | <DIR> | . |
| 05/06/2002 10:22a | <DIR> | .. |
| 05/06/2002 10:22a | 2,788 | UtilCriteriaBuilder.java |
| 05/06/2002 10:22a | 2,522 | XMLEntityReference.java |
| 05/06/2002 10:22a | 4,809 | XMLParser.java |
| 05/06/2002 10:22a | 4,070 | XMLWriter.java |

| | |
|---|---|
| 4 File(s) | 14,189 bytes |

Directory of com\agile\sandbox\pi\admin\view

| | | |
|---|---|---|
| 05/06/2002 10:22a | <DIR> | . |
| 05/06/2002 10:22a | <DIR> | .. |
| 05/06/2002 10:22a | <DIR> | web |

| | |
|---|---|
| 0 File(s) | 0 bytes |

Directory of com\agile\sandbox\pi\admin\view\web

| | | |
|---|---|---|
| 05/06/2002 10:22a | <DIR> | . |
| 05/06/2002 10:22a | <DIR> | .. |
| 05/06/2002 10:22a | 3,210 | BBIDownload.java |
| 05/06/2002 10:22a | <DIR> | handler |

| | |
|---|---|
| 1 File(s) | 3,210 bytes |

Directory of com\agile\sandbox\pi\admin\view\web\handler

| | | |
|---|---|---|
| 05/06/2002 10:22a | <DIR> | . |
| 05/06/2002 10:22a | <DIR> | .. |
| 05/06/2002 10:22a | 5,668 | FileTypeConvertRequestHandler.java |
| 05/06/2002 10:22a | 4,236 | ImportParserProfileRequestHandler.java |
| 05/06/2002 10:22a | 7,569 | ParseBomAmlRequestHandler.java |
| 05/06/2002 10:22a | 6,181 | ParserProfileRequestHandler.java |
| 05/06/2002 10:22a | 3,796 | ParserRecognitionTestRequestHandler.java |
| 05/06/2002 10:22a | 7,118 | ParseTestRequestHandler.java |

| | |
|---|---|
| 6 File(s) | 34,568 bytes |

Directory of com\agile\sandbox\pi\database

| | | |
|---|---|---|
| 05/06/2002 10:23a | <DIR> | . |
| 05/06/2002 10:23a | <DIR> | .. |
| 05/06/2002 10:22a | 22,882 | BaseFmaAccessFields.java |
| 05/06/2002 10:22a | 25,646 | BaseFmaAccessFieldsPeer.java |
| 05/06/2002 10:22a | 23,960 | BaseFmaAccounts.java |
| 05/06/2002 10:22a | 25,897 | BaseFmaAccountsPeer.java |
| 05/06/2002 10:22a | 15,112 | BaseFmaBoms.java |
| 05/06/2002 10:22a | 18,913 | BaseFmaBomsPeer.java |
| 05/06/2002 10:22a | 24,336 | BaseFmaCustomFields.java |
| 05/06/2002 10:22a | 26,268 | BaseFmaCustomFieldsPeer.java |
| 05/06/2002 10:22a | 25,315 | BaseFmaDashboardDetails.java |
| 05/06/2002 10:22a | 26,940 | BaseFmaDashboardDetailsPeer.java |
| 05/06/2002 10:22a | 32,492 | BaseFmaDashboards.java |
| 05/06/2002 10:22a | 39,956 | BaseFmaDashboardsPeer.java |
| 05/06/2002 10:22a | 28,420 | BaseFmaDenyFields.java |
| 05/06/2002 10:22a | 24,472 | BaseFmaDenyFieldsPeer.java |
| 05/06/2002 10:22a | 45,000 | BaseFmaDepositDetails.java |
| 05/06/2002 10:22a | 69,562 | BaseFmaDepositDetailsPeer.java |
| 05/06/2002 10:22a | 47,578 | BaseFmaDeposits.java |
| 05/06/2002 10:22a | 41,726 | BaseFmaDepositsPeer.java |
| 05/06/2002 10:22a | 24,448 | BaseFmaErrorLogs.java |
| 05/06/2002 10:22a | 26,201 | BaseFmaErrorLogsPeer.java |
| 05/06/2002 10:22a | 52,998 | BaseFmaFieldTypes.java |
| 05/06/2002 10:22a | 19,218 | BaseFmaFieldTypesPeer.java |
| 05/06/2002 10:22a | 17,873 | BaseFmaFileLevelDenials.java |
| 05/06/2002 10:22a | 22,052 | BaseFmaFileLevelDenialsPeer.java |
| 05/06/2002 10:22a | 32,576 | BaseFmaFileTypes.java |
| 05/06/2002 10:22a | 19,715 | BaseFmaFileTypesPeer.java |
| 05/06/2002 10:22a | 24,353 | BaseFmaFilters.java |
| 05/06/2002 10:22a | 19,563 | BaseFmaFiltersPeer.java |
| 05/06/2002 10:22a | 45,109 | BaseFmaGroupDepositDetails.java |
| 05/06/2002 10:22a | 26,652 | BaseFmaGroupDepositDetailsPeer.java |
| 05/06/2002 10:22a | 21,439 | BaseFmaKeyValueLookup.java |
| 05/06/2002 10:22a | 23,551 | BaseFmaKeyValueLookupPeer.java |
| 05/06/2002 10:22a | 29,592 | BaseFmaLocations.java |
| 05/06/2002 10:22a | 26,896 | BaseFmaLocationsPeer.java |
| 05/06/2002 10:22a | 16,445 | BaseFmaMessages.java |
| 05/06/2002 10:22a | 19,612 | BaseFmaMessagesPeer.java |
| 05/06/2002 10:22a | 27,112 | BaseFmaMetricEvents.java |
| 05/06/2002 10:22a | 27,567 | BaseFmaMetricEventsPeer.java |
| 05/06/2002 10:22a | 17,046 | BaseFmaMetricsEventLogs.java |
| 05/06/2002 10:22a | 20,107 | BaseFmaMetricsEventLogsPeer.java |
| 05/06/2002 10:22a | 13,378 | BaseFmaMetricsFileLogs.java |
| 05/06/2002 10:22a | 18,516 | BaseFmaMetricsFileLogsPeer.java |
| 05/06/2002 10:22a | 21,818 | BaseFmaMetricsTypes.java |
| 05/06/2002 10:22a | 19,350 | BaseFmaMetricsTypesPeer.java |
| 05/06/2002 10:22a | 42,054 | BaseFmaNodeCommands.java |
| 05/06/2002 10:22a | 44,477 | BaseFmaNodeCommandsPeer.java |
| 05/06/2002 10:22a | 42,982 | BaseFmaNodeViews.java |
| 05/06/2002 10:22a | 40,574 | BaseFmaNodeViewsPeer.java |
| 05/06/2002 10:22a | 163,097 | BaseFmaParties.java |
| 05/06/2002 10:22a | 23,527 | BaseFmaPartiesPeer.java |
| 05/06/2002 10:22a | 27,695 | BaseFmaPartyAliases.java |
| 05/06/2002 10:22a | 25,061 | BaseFmaPartyAliasesPeer.java |
| 05/06/2002 10:22a | 82,410 | BaseFmaPartyRelationships.java |
| 05/06/2002 10:22a | 46,215 | BaseFmaPartyRelationshipsPeer.java |
| 05/06/2002 10:22a | 18,457 | BaseFmaPartyTypes.java |
| 05/06/2002 10:22a | 18,750 | BaseFmaPartyTypesPeer.java |
| 05/06/2002 10:22a | 53,237 | BaseFmaPermissions.java |
| 05/06/2002 10:22a | 24,524 | BaseFmaPermissionsPeer.java |
| 05/06/2002 10:22a | 54,937 | BaseFmaProcesses.java |
| 05/06/2002 10:22a | 22,658 | BaseFmaProcessesPeer.java |
| 05/06/2002 10:22a | 72,022 | BaseFmaProcessInstances.java |
| 05/06/2002 10:22a | 79,937 | BaseFmaProcessInstancesPeer.java |
| 05/06/2002 10:22a | 40,315 | BaseFmaProcessPartyRelMap.java |
| 05/06/2002 10:22a | 40,812 | BaseFmaProcessPartyRelMapPeer.java |
| 05/06/2002 10:22a | 29,996 | BaseFmaProfiles.java |
| 05/06/2002 10:22a | 22,758 | BaseFmaProfilesPeer.java |
| 05/06/2002 10:22a | 7,439 | BaseFmaProfileUpdate.java |
| 05/06/2002 10:22a | 15,914 | BaseFmaProfileUpdatePeer.java |
| 05/06/2002 10:22a | 22,798 | BaseFmaProperties.java |
| 05/06/2002 10:22a | 22,379 | BaseFmaPropertiesPeer.java |
| 05/06/2002 10:22a | 26,990 | BaseFmaRelationshipTypes.java |
| 05/06/2002 10:22a | 19,712 | BaseFmaRelationshipTypesPeer.java |
| 05/06/2002 10:22a | 23,801 | BaseFmaRoleFiletypeMap.java |
| 05/06/2002 10:22a | 39,408 | BaseFmaRoleFiletypeMapPeer.java |
| 05/06/2002 10:22a | 21,166 | BaseFmaRolePartyMap.java |
| 05/06/2002 10:22a | 24,879 | BaseFmaRolePartyMapPeer.java |
| 05/06/2002 10:22a | 21,721 | BaseFmaRolePermissionMap.java |
| 05/06/2002 10:22a | 25,381 | BaseFmaRolePermissionMapPeer.java |
| 05/06/2002 10:22a | 57,079 | BaseFmaRoles.java |
| 05/06/2002 10:22a | 20,359 | BaseFmaRolesPeer.java |
| 05/06/2002 10:22a | 21,055 | BaseFmaRoleUserMap.java |
| 05/06/2002 10:22a | 24,775 | BaseFmaRoleUserMapPeer.java |
| 05/06/2002 10:22a | 19,256 | BaseFmaTableSequenceMap.java |
| 05/06/2002 10:22a | 22,659 | BaseFmaTableSequenceMapPeer.java |
| 05/06/2002 10:22a | 24,481 | BaseFmaTemplateCtrlDetails.java |
| 05/06/2002 10:22a | 26,745 | BaseFmaTemplateCtrlDetailsPeer.java |
| 05/06/2002 10:22a | 80,596 | BaseFmaTemplateDetails.java |
| 05/06/2002 10:22a | 32,021 | BaseFmaTemplateDetailsPeer.java |
| 05/06/2002 10:22a | 62,459 | BaseFmaTemplates.java |
| 05/06/2002 10:22a | 19,212 | BaseFmaTemplatesPeer.java |
| 05/06/2002 10:22a | 48,282 | BaseFmaUsers.java |
| 05/06/2002 10:22a | 26,641 | BaseFmaUsersPeer.java |
| 05/06/2002 10:22a | 11,825 | BaseFmaVersions.java |
| 05/06/2002 10:22a | 17,665 | BaseFmaVersionsPeer.java |
| 05/06/2002 10:22a | 18,708 | BaseFmaWorkflowTasks.java |
| 05/06/2002 10:22a | 20,723 | BaseFmaWorkflowTasksPeer.java |
| 05/06/2002 10:22a | 63,246 | BasePmAlgorithmModuleMap.java |
| 05/06/2002 10:22a | 23,012 | BasePmAlgorithmModuleMapPeer.java |
| 05/06/2002 10:22a | 43,442 | BasePmAlgorithmModules.java |
| 05/06/2002 10:22a | 20,376 | BasePmAlgorithmModulesPeer.java |
| 05/06/2002 10:22a | 19,765 | BasePmAlgorithmParameters.java |
| 05/06/2002 10:22a | 22,965 | BasePmAlgorithmParametersPeer.java |
| 05/06/2002 10:22a | 22,110 | BasePmBomFileMaps.java |
| 05/06/2002 10:22a | 25,197 | BasePmBomFileMapsPeer.java |
| 05/06/2002 10:22a | 74,362 | BasePmBomFiles.java |
| 05/06/2002 10:22a | 39,624 | BasePmBomFilesPeer.java |
| 05/06/2002 10:22a | 81,039 | BasePmBomPartDetails.java |
| 05/06/2002 10:22a | 42,378 | BasePmBomPartDetailsPeer.java |
| 05/06/2002 10:22a | 16,892 | BasePmBomPartMaps.java |
| 05/06/2002 10:22a | 19,861 | BasePmBomPartMapsPeer.java |
| 05/06/2002 10:22a | 26,360 | BasePmBomPartMatchMap.java |
| 05/06/2002 10:22a | 40,727 | BasePmBomPartMatchMapPeer.java |
| 05/06/2002 10:22a | 42,905 | BasePmBomParts.java |
| 05/06/2002 10:22a | 26,009 | BasePmBomPartsPeer.java |
| 05/06/2002 10:22a | 25,110 | BasePmCleanseLogs.java |
| 05/06/2002 10:22a | 26,560 | BasePmCleanseLogsPeer.java |
| 05/06/2002 10:22a | 14,239 | BasePmFileFormats.java |
| 05/06/2002 10:22a | 18,757 | BasePmFileFormatsPeer.java |
| 05/06/2002 10:22a | 25,194 | BasePmMappingLogs.java |
| 05/06/2002 10:22a | 26,620 | BasePmMappingLogsPeer.java |
| 05/06/2002 10:22a | 26,719 | BasePmMappingLookups.java |
| 05/06/2002 10:22a | 24,182 | BasePmMappingLookupsPeer.java |
| 05/06/2002 10:22a | 44,260 | BasePmMasterPartFeatures.java |
| 05/06/2002 10:22a | 31,827 | BasePmMasterPartFeaturesPeer.java |
| 05/06/2002 10:22a | 19,552 | BasePmParserLinePatterns.java |
| 05/06/2002 10:22a | 22,836 | BasePmParserLinePatternsPeer.java |
| 05/06/2002 10:22a | 86,635 | BasePmPartMatches.java |
| 05/06/2002 10:22a | 50,489 | BasePmPartMatchesPeer.java |
| 05/06/2002 10:22a | 26,234 | BasePmPartUsageForecast.java |
| 05/06/2002 10:22a | 27,376 | BasePmPartUsageForecastPeer.java |
| 05/06/2002 10:22a | 74,472 | BasePmPartVendorMaps.java |
| 05/06/2002 10:22a | 44,253 | BasePmPartVendorMapsPeer.java |
| 05/06/2002 10:22a | 24,727 | BasePmRecognitionLogs.java |
| 05/06/2002 10:22a | 26,597 | BasePmRecognitionLogsPeer.java |
| 05/06/2002 10:22a | 41,056 | BasePmReportLogs.java |
| 05/06/2002 10:22a | 31,948 | BasePmReportLogsPeer.java |
| 05/06/2002 10:22a | 25,920 | BasePmStandardizeLogs.java |
| 05/06/2002 10:22a | 27,134 | BasePmStandardizeLogsPeer.java |
| 05/06/2002 10:22a | 28,314 | BasePmSubscriptions.java |
| 05/06/2002 10:22a | 41,587 | BasePmSubscriptionsPeer.java |
| 05/06/2002 10:22a | 32,025 | BasePmValidationErrors.java |
| 05/06/2002 10:22a | 54,138 | BasePmValidationErrorsPeer.java |
| 05/06/2002 10:22a | 27,678 | BasePmValidationErrorTypes.java |
| 05/06/2002 10:22a | 20,225 | BasePmValidationErrorTypesPeer.java |
| 05/06/2002 10:22a | 36,900 | BasePmValidationLogs.java |
| 05/06/2002 10:22a | 27,362 | BasePmValidationLogsPeer.java |
| 05/06/2002 10:22a | 25,662 | BasePmVendors.java |
| 05/06/2002 10:22a | 22,481 | BasePmVendorsPeer.java |
| 05/06/2002 10:22a | 528 | FmaAccessFields.java |
| 05/06/2002 10:22a | 667 | FmaAccessFieldsPeer.java |
| 05/06/2002 10:22a | 520 | FmaAccounts.java |
| 05/06/2002 10:22a | 659 | FmaAccountsPeer.java |
| 05/06/2002 10:22a | 512 | FmaBoms.java |
| 05/06/2002 10:22a | 651 | FmaBomsPeer.java |
| 05/06/2002 10:22a | 528 | FmaCustomFields.java |
| 05/06/2002 10:22a | 667 | FmaCustomFieldsPeer.java |
| 05/06/2002 10:22a | 536 | FmaDashboardDetails.java |
| 05/06/2002 10:22a | 675 | FmaDashboardDetailsPeer.java |
| 05/06/2002 10:22a | 524 | FmaDashboards.java |
| 05/06/2002 10:22a | 663 | FmaDashboardsPeer.java |
| 05/06/2002 10:22a | 524 | FmaDenyFields.java |
| 05/06/2002 10:22a | 663 | FmaDenyFieldsPeer.java |
| 05/06/2002 10:22a | 532 | FmaDepositDetails.java |
| 05/06/2002 10:22a | 671 | FmaDepositDetailsPeer.java |
| 05/06/2002 10:22a | 520 | FmaDeposits.java |
| 05/06/2002 10:22a | 659 | FmaDepositsPeer.java |
| 05/06/2002 10:22a | 522 | FmaErrorLogs.java |
| 05/06/2002 10:22a | 661 | FmaErrorLogsPeer.java |
| 05/06/2002 10:22a | 524 | FmaFieldTypes.java |
| 05/06/2002 10:22a | 663 | FmaFieldTypesPeer.java |
| 05/06/2002 10:22a | 536 | FmaFileLevelDenials.java |
| 05/06/2002 10:22a | 675 | FmaFileLevelDenialsPeer.java |
| 05/06/2002 10:22a | 522 | FmaFileTypes.java |
| 05/06/2002 10:22a | 661 | FmaFileTypesPeer.java |
| 05/06/2002 10:22a | 518 | FmaFilters.java |
| 05/06/2002 10:22a | 657 | FmaFiltersPeer.java |
| 05/06/2002 10:22a | 542 | FmaGroupDepositDetails.java |
| 05/06/2002 10:22a | 681 | FmaGroupDepositDetailsPeer.java |
| 05/06/2002 10:22a | 532 | FmaKeyValueLookup.java |
| 05/06/2002 10:22a | 671 | FmaKeyValueLookupPeer.java |
| 05/06/2002 10:22a | 522 | FmaLocations.java |
| 05/06/2002 10:22a | 661 | FmaLocationsPeer.java |
| 05/06/2002 10:22a | 520 | FmaMessages.java |
| 05/06/2002 10:22a | 659 | FmaMessagesPeer.java |
| 05/06/2002 10:22a | 528 | FmaMetricEvents.java |
| 05/06/2002 10:22a | 667 | FmaMetricEventsPeer.java |
| 05/06/2002 10:22a | 536 | FmaMetricsEventLogs.java |
| 05/06/2002 10:22a | 675 | FmaMetricsEventLogsPeer.java |
| 05/06/2002 10:22a | 534 | FmaMetricsFileLogs.java |
| 05/06/2002 10:22a | 673 | FmaMetricsFileLogsPeer.java |
| 05/06/2002 10:22a | 528 | FmaMetricsTypes.java |
| 05/06/2002 10:22a | 667 | FmaMetricsTypesPeer.java |
| 05/06/2002 10:22a | 528 | FmaNodeCommands.java |
| 05/06/2002 10:22a | 667 | FmaNodeCommandsPeer.java |
| 05/06/2002 10:22a | 522 | FmaNodeViews.java |
| 05/06/2002 10:22a | 661 | FmaNodeViewsPeer.java |
| 05/06/2002 10:22a | 518 | FmaParties.java |
| 05/06/2002 10:22a | 657 | FmaPartiesPeer.java |
| 05/06/2002 10:22a | 528 | FmaPartyAliases.java |
| 05/06/2002 10:22a | 667 | FmaPartyAliasesPeer.java |
| 05/06/2002 10:22a | 540 | FmaPartyRelationships.java |
| 05/06/2002 10:22a | 679 | FmaPartyRelationshipsPeer.java |
| 05/06/2002 10:22a | 524 | FmaPartyTypes.java |
| 05/06/2002 10:22a | 663 | FmaPartyTypesPeer.java |
| 05/06/2002 10:22a | 526 | FmaPermissions.Java |
| 05/06/2002 10:22a | 665 | FmaPermissionsPeer.java |
| 05/06/2002 10:22a | 522 | FmaProcesses.java |
| 05/06/2002 10:22a | 661 | FmaProcessesPeer.java |
| 05/06/2002 10:22a | 536 | FmaProcess Instances.java |
| 05/06/2002 10:22a | 675 | FmaProcessInstancesPeer.java |
| 05/06/2002 10:22a | 540 | FmaProcessPartyRelMap.java |
| 05/06/2002 10:22a | 679 | FmaProcessPartyRelMapPeer.java |
| 05/06/2002 10:22a | 520 | FmaProfiles.java |
| 05/06/2002 10:22a | 659 | FmaProfilesPeer.java |
| 05/06/2002 10:22a | 530 | FmaProfileUpdate.java |
| 05/06/2002 10:22a | 669 | FmaProfileUpdatePeer.java |
| 05/06/2002 10:22a | 524 | FmaProperties.java |
| 05/06/2002 10:22a | 663 | FmaPropertiesPeer.java |
| 05/06/2002 10:22a | 538 | FmaRelationshipTypes.java |
| 05/06/2002 10:22a | 677 | FmaRelationshipTypesPeer.java |
| 05/06/2002 10:22a | 534 | FmaRoleFiletypeMap.java |
| 05/06/2002 10:22a | 673 | FmaRoleFiletypeMapPeer.java |
| 05/06/2002 10:22a | 528 | FmaRolePartyMap.java |
| 05/06/2002 10:22a | 667 | FmaRolePartyMapPeer.java |
| 05/06/2002 10:22a | 538 | FmaRolePermissionMap.java |
| 05/06/2002 10:22a | 677 | FmaRolePermissionMapPeer.java |
| 05/06/2002 10:22a | 514 | FmaRoles.java |
| 05/06/2002 10:22a | 653 | FmaRolesPeer.java |
| 05/06/2002 10:22a | 526 | FmaRoleUserMap.java |
| 05/06/2002 10:22a | 665 | FmaRoleUserMapPeer.java |
| 05/06/2002 10:22a | 536 | FmaTableSequenceMap.java |
| 05/06/2002 10:22a | 675 | FmaTableSequenceMapPeer.java |
| 05/06/2002 10:22a | 542 | FmaTemplateCtrlDetails.java |
| 05/06/2002 10:22a | 681 | FmaTemplateCtrlDetailsPeer.java |
| 05/06/2002 10:22a | 534 | FmaTemplateDetails.java |
| 05/06/2002 10:22a | 673 | FmaTemplateDetailsPeer.java |
| 05/06/2002 10:22a | 522 | FmaTemplates.java |
| 05/06/2002 10:22a | 661 | FmaTemplatesPeer.java |
| 05/06/2002 10:22a | 514 | FmaUsers.java |
| 05/06/2002 10:22a | 653 | FmaUsersPeer.java |
| 05/06/2002 10:22a | 520 | FmaVersions.java |
| 05/06/2002 10:22a | 659 | FmaVersionsPeer.java |
| 05/06/2002 10:22a | 530 | FmaWorkflowTasks.java |
| 05/06/2002 10:22a | 669 | FmaWorkflowTasksPeer.java |
| 05/06/2002 10:22a | <DIR> | map |
| 05/06/2002 10:22a | 538 | PmAlgorithmModuleMap.java |
| 05/06/2002 10:22a | 677 | PmAlgorithmModuleMapPeer.java |
| 05/06/2002 10:22a | 534 | PmAlgorithmModules.java |
| 05/06/2002 10:22a | 673 | PmAlgorithmModulesPeer.java |
| 05/06/2002 10:22a | 540 | PmAlgorithmParameters.java |
| 05/06/2002 10:22a | 679 | PmAlgorithmParametersPeer.java |
| 05/06/2002 10:22a | 524 | PmBomFileMaps.java |
| 05/06/2002 10:22a | 663 | PmBomFileMapsPeer.java |
| 05/06/2002 10:22a | 518 | PmBomFiles.java |
| 05/06/2002 10:22a | 657 | PmBomFilesPeer.java |
| 05/06/2002 10:22a | 530 | PmBomPartDetails.java |
| 05/06/2002 10:22a | 669 | PmBomPartDetailsPeer.java |
| 05/06/2002 10:23a | 524 | PmBomPartMaps.java |
| 05/06/2002 10:23a | 663 | PmBomPartMapsPeer.java |
| 05/06/2002 10:23a | 532 | PmBomPartMatchMap.java |
| 05/06/2002 10:23a | 671 | PmBomPartMatchMapPeer.java |
| 05/06/2002 10:23a | 518 | PmBomParts.java |
| 05/06/2002 10:23a | 657 | PmBomPartsPeer.java |
| 05/06/2002 10:23a | 524 | PmCleanseLogs.java |
| 05/06/2002 10:23a | 663 | PmCleanseLogsPeer.java |
| 05/06/2002 10:23a | 524 | PmFileFormats.java |
| 05/06/2002 10:23a | 663 | PmFileFormatsPeer.java |
| 05/06/2002 10:23a | 524 | PmMappingLogs.java |
| 05/06/2002 10:23a | 663 | PmMappingLogsPeer.java |
| 05/06/2002 10:23a | 530 | PmMappingLookups.java |
| 05/06/2002 10:23a | 669 | PmMappingLookupsPeer.java |
| 05/06/2002 10:23a | 538 | PmMasterPartFeatures.java |
| 05/06/2002 10:23a | 677 | PmMasterPartFeaturesPeer.java |
| 05/06/2002 10:23a | 538 | PmParserLinePatterns.java |
| 05/06/2002 10:23a | 677 | PmParserLinePatternsPeer.java |
| 05/06/2002 10:23a | 524 | PmPartMatches.java |
| 05/06/2002 10:23a | 663 | PmPartMatchesPeer.java |
| 05/06/2002 10:23a | 536 | PmPartUsageForecast.java |
| 05/06/2002 10:23a | 675 | PmPartUsageForecastPeer.java |
| 05/06/2002 10:23a | 530 | PmPartVendorMaps.java |
| 05/06/2002 10:23a | 669 | PmPartVendorMapsPeer.java |
| 05/06/2002 10:23a | 532 | PmRecognitionLogs.java |
| 05/06/2002 10:23a | 671 | PmRecognitionLogsPeer.java |
| 05/06/2002 10:23a | 522 | PmReportLogs.java |
| 05/06/2002 10:23a | 661 | PmReportLogsPeer.java |
| 05/06/2002 10:23a | 532 | PmStandardizeLogs.java |
| 05/06/2002 10:23a | 671 | PmStandardizeLogsPeer.java |
| 05/06/2002 10:23a | 528 | PmSubscriptions.java |
| 05/06/2002 10:23a | 667 | PmSubscriptionsPeer.java |
| 05/06/2002 10:23a | 534 | PmValidationErrors.java |
| 05/06/2002 10:23a | 673 | PmValidationErrorsPeer.java |
| 05/06/2002 10:23a | 542 | PmValidationErrorTypes.java |
| 05/06/2002 10:23a | 681 | PmValidationErrorTypesPeer.java |
| 05/06/2002 10:23a | 530 | PmValidationLogs.java |
| 05/06/2002 10:23a | 669 | PmValidationLogsPeer.java |
| 05/06/2002 10:23a | 516 | PmVendors.java |
| 05/06/2002 10:23a | 655 | PmVendorsPeer.java |

| | |
|---|---|
| 296 File(s) | 4,888,079 bytes |

Directory of com\agile\sandbox\pi\dataBase\map

| | | |
|---|---|---|
| 05/06/2002 10:22a | <DIR> | . |
| 05/06/2002 10:22a | <DIR> | .. |
| 05/06/2002 10:22a | 5,014 | FmaAccessFieldsMapBuilder.java |
| 05/06/2002 10:22a | 5,179 | FmaAccountsMapBuilder.java |
| 05/06/2002 10:22a | 3,879 | FmaBomsMapBuilder.java |
| 05/06/2002 10:22a | 5,386 | FmaCustomFieldsMapBuilder.java |
| 05/06/2002 10:22a | 5,783 | FmaDashboardDetailsMapBuilder.java |
| 05/06/2002 10:22a | 5,288 | FmaDashboardsMapBuilder.java |
| 05/06/2002 10:22a | 4,326 | FmaDenyFieldsMapBuilder.java |
| 05/06/2002 10:22a | 7,613 | FmaDepositDetailsMapBuilder.java |
| 05/06/2002 10:22a | 6,130 | FmaDepositsMapBuilder.java |
| 05/06/2002 10:22a | 5,427 | FmaErrorLogsMapBuilder.java |
| 05/06/2002 10:22a | 4,082 | FmaFieldTypesMapBuilder.java |
| 05/06/2002 10:22a | 4,347 | FmaFileLevelDenialsMapBuilder.java |
| 05/06/2002 10:22a | 4,388 | FmaFileTypesMapBuilder.java |
| 05/06/2002 10:22a | 4,282 | FmaFiltersMapBuilder.java |
| 05/06/2002 10:22a | 5,595 | FmaGroupDepositDetailsMapBuilder.java |
| 05/06/2002 10:22a | 5,250 | FmaKeyValueLookupMapBuilder.java |
| 05/06/2002 10:22a | 7,300 | FmaLocationsMapBuilder.java |
| 05/06/2002 10:22a | 4,316 | FmaMessagesMapBuilder.java |
| 05/06/2002 10:22a | 6,222 | FmaMetricEventsMapBuilder.java |
| 05/06/2002 10:22a | 4,678 | FmaMetricsEventLogsMapBuilder.java |
| 05/06/2002 10:22a | 3,628 | FmaMetricsFileLogsMapBuilder.java |
| 05/06/2002 10:22a | 4,166 | FmaMetricsTypesMapBuilder.java |
| 05/06/2002 10:22a | 7,543 | FmaNodeCommandsMapBuilder.java |
| 05/06/2002 10:22a | 5,556 | FmaNodeViewsMapBuilder.java |
| 05/06/2002 10:22a | 5,233 | FmaPartiesMapBuilder.java |
| 05/06/2002 10:22a | 4,606 | FmaPartyAliasesMapBuilder.java |
| 05/06/2002 10:22a | 5,421 | FmaPartyRelationshipsMapBuilder.java |
| 05/06/2002 10:22a | 3,786 | FmaPartyTypesMapBuilder.java |
| 05/06/2002 10:22a | 5,915 | FmaPermissionsMapBuilder.java |
| 05/06/2002 10:22a | 4,722 | FmaProcessesMapBuilder.java |
| 05/06/2002 10:22a | 7,245 | FmaProcessInstancesMapBuilder.java |
| 05/06/2002 10:22a | 5,335 | FmaProcessPartyRelMapMapBuilder.java |
| 05/06/2002 10:22a | 6,247 | FmaProfilesMapBuilder.java |
| 05/06/2002 10:22a | 1,959 | FmaProfileUpdateMapBuilder.java |
| 05/06/2002 10:22a | 6,048 | FmaPropertiesMapBuilder.java |
| 05/06/2002 10:22a | 4,389 | FmaRelationshipTypesMapBuilder.java |
| 05/06/2002 10:22a | 4,841 | FmaRoleFiletypeMapMapBuilder.java |
| 05/06/2002 10:22a | 4,630 | FmaRolePartyMapMapBuilder.java |
| 05/06/2002 10:22a | 4,853 | FmaRolePermissionMapMapBuilder.java |
| 05/06/2002 10:22a | 4,754 | FmaRolesMapBuilder.java |
| 05/06/2002 10:22a | 4,589 | FmaRoleUserMapMapBuilder.java |
| 05/06/2002 10:22a | 4,725 | FmaTableSequenceMapMapBuilder.java |
| 05/06/2002 10:22a | 5,643 | FmaTemplateCtrlDetailsMapBuilder.java |
| 05/06/2002 10:22a | 8,974 | FmaTemplateDetailsMapBuilder.java |
| 05/06/2002 10:22a | 4,068 | FmaTemplatesMapBuilder.java |
| 05/06/2002 10:22a | 5,556 | FmaUsersMapBuilder.java |
| 05/06/2002 10:22a | 3,116 | FmaVersionsMapBuilder.java |
| 05/06/2002 10:22a | 5,067 | FmaWorkflowTasksMapBuilder.java |
| 05/06/2002 10:22a | 4,962 | PmAlgorithmModuleMapMapBuilder.java |
| 05/06/2002 10:22a | 4,843 | PmAlgorithmModulesMapBuilder.java |
| 05/06/2002 10:22a | 4,834 | PmAlgorithmParametersMapBuilder.java |
| 05/06/2002 10:22a | 4,650 | PmBomFileMapsMapBuilder.java |
| 05/06/2002 10:22a | 4,979 | PmBomFilesMapBuilder.java |
| 05/06/2002 10:22a | 17,030 | PmBomPartDetailsMapBuilder.java |
| 05/06/2002 10:22a | 4,490 | PmBomPartMapsMapBuilder.java |
| 05/06/2002 10:22a | 5,500 | PmBomPartMatchMapMapBuilder.java |
| 05/06/2002 10:22a | 5,321 | PmBomPartsMapBuilder.java |
| 05/06/2002 10:22a | 5,574 | PmCleanseLogsMapBuilder.java |
| 05/06/2002 10:22a | 3,790 | PmFileFormatsMapBuilder.java |
| 05/06/2002 10:22a | 5,608 | PmMappingLogsMapBuilder.java |
| 05/06/2002 10:22a | 7,283 | PmMappingLookupsMapBuilder.java |
| 05/06/2002 10:22a | 12,472 | PmMasterPartFeaturesMapBuilder.java |
| 05/06/2002 10:22a | 4,779 | PmParserLinePatternsMapBuilder.java |
| 05/06/2002 10:22a | 19,781 | PmPartMatchesMapBuilder.java |
| 05/06/2002 10:22a | 6,112 | PmPartUsageForecastMapBuilder.java |
| 05/06/2002 10:22a | 16,332 | PmPartVendorMapsMapBuilder.java |
| 05/06/2002 10:22a | 5,507 | PmRecognitionLogsMapBuilder.java |
| 05/06/2002 10:22a | 10,307 | PmReportLogsMapBuilder.java |
| 05/06/2002 10:22a | 5,838 | PmStandardizeLogsMapBuilder.java |
| 05/06/2002 10:22a | 5,874 | PmSubscriptionsMapBuilder.java |
| 05/06/2002 10:22a | 6,412 | PmValidationErrorsMapBuilder.java |
| 05/06/2002 10:22a | 4,748 | PmValidationErrorTypesMapBuilder.java |
| 05/06/2002 10:22a | 6,049 | PmValidationLogsMapBuilder.java |
| 05/06/2002 10:22a | 4,624 | PmVendorsMapBuilder.java |

| | |
|---|---|
| 74 File(s) | 434,799 bytes |

Directory of com\agile\sandbox\pi\fma

| | | |
|---|---|---|
| 05/06/2002 10:23a | <DIR> | . |
| 05/06/2002 10:23a | <DIR> | .. |
| 05/06/2002 10:23a | <DIR> | common |
| 05/06/2002 10:23a | <DIR> | components |
| 05/06/2002 10:23a | <DIR> | controller |
| 05/06/2002 10:23a | <DIR> | custom |
| 05/06/2002 10:23a | <DIR> | eventhandlers |
| 05/06/2002 10:23a | <DIR> | events |
| 05/06/2002 10:23a | <DIR> | model |
| 05/06/2002 10:23a | <DIR> | repository |
| 05/06/2002 10:23a | <DIR> | transformation |
| 05/06/2002 10:23a | <DIR> | utils |
| 05/06/2002 10:23a | <DIR> | view |
| 05/06/2002 10:23a | <DIR> | workflow |

| | |
|---|---|
| 0 File(s) | 0 bytes |

Directory of com\agile\sandbox\pi\fma\common

| | | |
|---|---|---|
| 05/06/2002 10:23a | <DIR> | . |
| 05/06/2002 10:23a | <DIR> | .. |
| 05/06/2002 10:23a | 9,006 | AgileEHubServer.java |
| 05/06/2002 10:23a | 9,944 | ApplicationLifecycle.html |
| 05/06/2002 10:23a | 1,713 | ApplicationLifecycle.java |
| 05/06/2002 10:23a | 1,689 | ConfigProperties.java |
| 05/06/2002 10:23a | 229 | EHubException.java |
| 05/06/2002 10:23a | 4,591 | ErrorMsgs.java |
| 05/06/2002 10:23a | 14,086 | GlobalConstants.java |
| 05/06/2002 10:23a | 3,226 | Lookup.java |
| 05/06/2002 10:23a | 4,157 | Sequence.java |
| 05/06/2002 10:23a | 245 | SequenceException.java |
| 05/06/2002 10:23a | 942 | ShutdownApplication.java |
| 05/06/2002 10:23a | 2,338 | StartupApplication.java |
| 05/06/2002 10:23a | 4,686 | SystemConstants.java |
| 05/06/2002 10:23a | <DIR> | test |

| | |
|---|---|
| 13 File(s) | 56,852 bytes |

Directory of com\agile\sandbox\pi\fma\common\test

| | | |
|---|---|---|
| 05/06/2002 10:23a | <DIR> | . |
| 05/06/2002 10:23a | <DIR> | .. |
| 05/06/2002 10:23a | 2,549 | AgileEHubServerTest.java |

| | |
|---|---|
| 1 File(s) | 2,549 bytes |

Directory of com\agile\sandbox\pi\fma\components

| | | |
|---|---|---|
| 05/06/2002 10:23a | <DIR> | . |
| 05/06/2002 10:23a | <DIR> | .. |
| 05/06/2002 10:23a | <DIR> | account |
| 05/06/2002 10:23a | <DIR> | collect |
| 05/06/2002 10:23a | <DIR> | epackage |
| 05/06/2002 10:23a | <DIR> | metrics |

| | |
|---|---|
| 0 File(s) | 0 bytes |

Directory of com\agile\sandbox\pi\fma\components\account

| | | |
|---|---|---|
| 05/06/2002 10:23a | <DIR> | . |
| 05/06/2002 10:23a | <DIR> | .. |
| 05/06/2002 10:23a | <DIR> | dao |
| 05/06/2002 10:23a | 4,993 | User.java |

| | |
|---|---|
| 1 File(s) | 4,993 bytes |

Directory of com\agile\sandbox\pi\fma\components\account\dao

| | | |
|---|---|---|
| 05/06/2002 10:23a | <DIR> | . |
| 05/06/2002 10:23a | <DIR> | .. |
| 05/06/2002 10:23a | 13,275 | AccountDAO.java |

| | |
|---|---|
| 1 File(s) | 13,275 bytes |

Directory of com\agile\sandbox\pi\fma\components\collect

| | | |
|---|---|---|
| 05/06/2002 10:23a | <DIR> | . |
| 05/06/2002 10:23a | <DIR> | .. |
| 05/06/2002 10:23a | 13,143 | CollectTemplate.java |
| 05/06/2002 10:23a | <DIR> | dao |
| 05/06/2002 10:23a | 6,392 | PlatformCommands.java |
| 05/06/2002 10:23a | 13,313 | TailorViewTemplate.java |
| 05/06/2002 10:23a | 332 | Template.java |
| 05/06/2002 10:23a | 5,354 | ViewButton.java |
| 05/06/2002 10:23a | 10,593 | ViewTemplate.java |

| | |
|---|---|
| 6 File(s) | 49,127 bytes |

Directory of com\agile\sandbox\pi\fma\components\collect\dao

| | | |
|---|---|---|
| 05/06/2002 10:23a | <DIR> | . |
| 05/06/2002 10:23a | <DIR> | .. |
| 05/06/2002 10:23a | 36,304 | CollectDAO.java |

| | |
|---|---|
| 1 File(s) | 36,304 bytes |

Directory of com\agile\sandbox\pi\fma\components\epackage

| | | |
|---|---|---|
| 05/06/2002 10:23a | <DIR> | . |
| 05/06/2002 10:23a | <DIR> | .. |
| 05/06/2002 10:23a | 474 | CompletePackage.java |
| 05/06/2002 10:23a | <DIR> | dao |
| 05/06/2002 10:23a | 3,409 | HistoryItem.java |
| 05/06/2002 10:23a | 2,373 | PackageTerminator.java |
| 05/06/2002 10:23a | 2,691 | PackageView.java |
| 05/06/2002 10:23a | 3,180 | ViewFieldItem.java |

| | |
|---|---|
| 5 File(s) | 12,127 bytes |

Directory of com\agile\sandbox\pi\fma\components\epackage\dao

| | | |
|---|---|---|
| 05/06/2002 10:23a | <DIR> | . |
| 05/06/2002 10:23a | <DIR> | .. |
| 05/06/2002 10:23a | 67,799 | EpackageDAO.java |
| 05/06/2002 10:23a | 8,954 | EpackageDelegate.java |

| | |
|---|---|
| 2 File(s) | 76,753 bytes |

Directory of com\agile\sandbox\pi\fma\components\metrics

| | | |
|---|---|---|
| 05/06/2002 10:23a | <DIR> | . |
| 05/06/2002 10:23a | <DIR> | .. |
| 05/06/2002 10:23a | <DIR> | dao |
| 05/06/2002 10:23a | 1,225 | FileMetricsLog.java |
| 05/06/2002 10:23a | 2,759 | MetricsLog.java |
| 05/06/2002 10:23a | 2,306 | MetricsUtil.java |

| | |
|---|---|
| 3 File(s) | 6,290 bytes |

Directory of com\agile\sandbox\pi\fma\components\metrics\dao

| | | |
|---|---|---|
| 05/06/2002 10:23a | <DIR> | . |
| 05/06/2002 10:23a | <DIR> | .. |
| 05/06/2002 10:23a | 5,029 | MetricsDAO.java |

| | |
|---|---|
| 1 File(s) | 5,029 bytes |

Directory of com\agile\sandbox\pi\fma\controller

| | | |
|---|---|---|
| 05/06/2002 10:23a | <DIR> | . |
| 05/06/2002 10:23a | <DIR> | .. |
| 05/06/2002 10:23a | 2,992 | EventController.java |
| 05/06/2002 10:23a | 438 | EventControllerException.java |

| | |
|---|---|
| 2 File(s) | 3,430 bytes |

Directory of com\agile\sandbox\pi\fma\custom

| | | |
|---|---|---|
| 05/06/2002 10:23a | <DIR> | . |
| 05/06/2002 10:23a | <DIR> | .. |
| 05/06/2002 10:23a | 11,246 | APWCustomCTFAlgorithm.java |
| 05/06/2002 10:23a | 9,184 | APWCustomSubCTFAlgorithm.java |
| 05/06/2002 10:23a | 5,830 | CustomDropDown.java |
| 05/06/2002 10:23a | 3,768 | CustomItem.java |
| 05/06/2002 10:23a | 8,966 | CustomSQLBasedDropDown.java |
| 05/06/2002 10:23a | 7,516 | SLRCustomCEAustList.java |
| 05/06/2002 10:23a | 7,516 | SLRCustomCECharList.java |
| 05/06/2002 10:23a | 7,561 | SLRCustomCEList.java |
| 05/06/2002 10:23a | 7,516 | SLRCustomCEMilpList.java |
| 05/06/2002 10:23a | 8,271 | SLRCustomCESiteList.java |
| 05/06/2002 10:23a | 6,497 | SLRCustomCustomerList.java |
| 05/06/2002 10:23a | 6,236 | SmartCustomCheckerList.java |
| 05/06/2002 10:23a | 8,554 | SmartCustomIdGenerator.java |
| 05/06/2002 10:23a | 10,177 | SmartCustomPartNumber.java |
| 05/06/2002 10:23a | <DIR> | test |

| | |
|---|---|
| 14 File(s) | 108, 838 bytes |

| | | |
|---|---|---|
| 05/06/2002 10:23a | <DIR> | . |
| 05/06/2002 10:23a | <DIR> | .. |
| 05/06/2002 10:23a | 3,771 | SLRCustomCESiteListTest.java |

| | |
|---|---|
| 1 File(s) | 3,771 bytes |

Directory of com\agile\sandbox\pi\fma\eventhandlers

| | | |
|---|---|---|
| 05/06/2002 10:23a | <DIR> | . |
| 05/06/2002 10:23a | <DIR> | .. |
| 05/06/2002 10:23a | 456 | AbsEventHandler.java |
| 05/06/2002 10:23a | 6,018 | ActivePackageEH.java |
| 05/06/2002 10:23a | 8,949 | CheckOutEH.java |
| 05/06/2002 10:23a | 5,803 | CollectEH.java |
| 05/06/2002 10:23a | 17,890 | CopyEH.java |
| 05/06/2002 10:23a | 1,063 | EventHandler.java |
| 05/06/2002 10:23a | 432 | EventHandlerException.java |
| 05/06/2002 10:23a | 4,658 | ForgotPasswordEH.java |
| 05/06/2002 10:23a | 11,209 | LaunchEH.java |
| 05/06/2002 10:23a | 12,373 | LaunchRequestEH.java |
| 05/06/2002 10:23a | 11,644 | ModifyEH.java |
| 05/06/2002 10:23a | 7,489 | ModifyRequestEH.java |
| 05/06/2002 10:23a | 3,179 | MultiFileLaunchEH.java |
| 05/06/2002 10:23a | 4,710 | PasswordUpdateEH.java |
| 05/06/2002 10:23a | 16,034 | PortalEH.java |
| 05/06/2002 10:23a | 4,618 | ReassignEH.java |
| 05/06/2002 10:23a | 38,783 | SearchEH.java |
| 05/06/2002 10:23a | 3,181 | SearchEHBase.java |
| 05/06/2002 10:23a | 12,080 | ServiceEH.java |
| 05/06/2002 10:23a | 26,159 | SimpleSearchEH.java |
| 05/06/2002 10:23a | 13,790 | SourceDestEH.java |
| 05/06/2002 10:23a | 2,956 | TabControllerEH.java |
| 05/06/2002 10:23a | <DIR> | test |
| 05/06/2002 10:23a | 7,421 | TodoEH.java |
| 05/06/2002 10:23a | 19,664 | ViewEH.java |

| | |
|---|---|
| 24 File(s) | 240, 559 bytes |

| | | |
|---|---|---|
| 05/06/2002 10:23a | <DIR> | . |
| 05/06/2002 10:23a | <DIR> | .. |
| 05/06/2002 10:23a | 5,450 | CopyEHTest.java |
| 05/06/2002 10:23a | 10,469 | SearchEHTest.java |
| 05/06/2002 10:23a | 9,938 | SimpleSearchEHTest.java |

| | |
|---|---|
| 3 File(s) | 25,857 bytes |

Directory of com\agile\sandbox\pi\fma\events

| | | |
|---|---|---|
| 05/06/2002 10:23a | <DIR> | . |
| 05/06/2002 10:23a | <DIR> | .. |
| 05/06/2002 10:23a | 4,343 | AbsEvent.java |
| 05/06/2002 10:23a | 806 | ActivePackageEvent.java |
| 05/06/2002 10:23a | 16,097 | CollectEvent.java |
| 05/06/2002 10:23a | 3,265 | CopyEvent.java |
| 05/06/2002 10:23a | 2,026 | DistributeEvent.java |
| 05/06/2002 10:23a | 2,127 | Event.java |
| 05/06/2002 10:23a | 2,111 | EventErrors.java |
| 05/06/2002 10:23a | 1,040 | ForgotPasswordEvent.java |
| 05/06/2002 10:23a | 2,224 | PasswordUpdateEvent.java |
| 05/06/2002 10:23a | 1,600 | PortalEvent.java |
| 05/06/2002 10:23a | 1,520 | ReassignEvent.java |
| 05/06/2002 10:23a | 14,145 | SearchEvent.java |
| 05/06/2002 10:23a | 1,601 | ServiceEvent.java |
| 05/06/2002 10:23a | 2,711 | SignInEvent.java |
| 05/06/2002 10:23a | 1,121 | SignOutEvent.java |
| 05/06/2002 10:23a | 4,322 | SimpleSearchEvent.java |
| 05/06/2002 10:23a | 1,039 | SourceDestEvent.java |
| 05/06/2002 10:23a | 718 | TabControllerEvent.java |
| 05/06/2002 10:23a | 1,176 | TodoEvent.java |
| 05/06/2002 10:23a | 1,118 | UploadEvent.java |
| 05/06/2002 10:23a | 3,470 | ViewEvent.java |

| | |
|---|---|
| 21 File(s) | 68,580 bytes |

Directory of com\agile\sandbox\pi\fma\model

| | | |
|---|---|---|
| 05/06/2002 10:23a | <DIR> | . |
| 05/06/2002 10:23a | <DIR> | .. |
| 05/06/2002 10:23a | 366 | AbsModel.java |
| 05/06/2002 10:23a | 4,221 | AutoItem.java |
| 05/06/2002 10:23a | 9,056 | CheckRadioItem.java |
| 05/06/2002 10:23a | 4,085 | ColumnHeader.java |
| 05/06/2002 10:23a | 8,951 | ControlTextItem.java |
| 05/06/2002 10:23a | 11,593 | CustomModel.java |
| 05/06/2002 10:23a | 2,298 | DashboardModel.java |
| 05/06/2002 10:23a | 3,037 | DateItem.java |
| 05/06/2002 10:23a | 5,181 | DropDownItem.java |
| 05/06/2002 10:23a | 2,300 | ErrorModel.java |
| 05/06/2002 10:23a | 5,736 | FileItem.java |
| 05/06/2002 10:23a | 2,037 | FileOthersItem.java |
| 05/06/2002 10:23a | 2,171 | ForgotPasswordModel.java |
| 05/06/2002 10:23a | 2,438 | HeaderItem.java |
| 05/06/2002 10:23a | 3,233 | HiddenItem.java |
| 05/06/2002 10:23a | 3,239 | HyperLinkItem.java |
| 05/06/2002 10:23a | 2,455 | InstructionsItem.java |
| 05/06/2002 10:23a | 724 | Model.java |
| 05/06/2002 10:23a | 2,513 | MultiFileItem.java |
| 05/06/2002 10:23a | 3,133 | OptionItem.java |
| 05/06/2002 10:23a | 1,484 | PageModel.java |
| 05/06/2002 10:23a | 3,405 | ParseFileItem.java |
| 05/06/2002 10:23a | 4,597 | PasswordUpdateModel.java |
| 05/06/2002 10:23a | 8,947 | SearchModel.java |
| 05/06/2002 10:23a | 5,614 | SelectItem.java |
| 05/06/2002 10:23a | 2,818 | SelectRowItem.java |
| 05/06/2002 10:23a | 1,748 | SimpleSearchResultsModel.java |
| 05/06/2002 10:23a | 3,453 | SourceDestModel.java |
| 05/06/2002 10:23a | 5,152 | SummaryModel.java |
| 05/06/2002 10:23a | 4,331 | TableModel.java |
| 05/06/2002 10:23a | 544 | TemplateItem.java |
| 05/06/2002 10:23a | 5,246 | TextAreaItem.java |
| 05/06/2002 10:23a | 4,950 | TextBoxItem.java |
| 05/06/2002 10:23a | 3,965 | TextItem.java |
| 05/06/2002 10:23a | 1,909 | UploadStatusModel.java |

| | |
|---|---|
| 35 File(s) | 136, 930 bytes |

Directory of com\agile\sandbox\pi\fma\repository

| | | |
|---|---|---|
| 05/06/2002 10:23a | <DIR> | . |
| 05/06/2002 10:23a | <DIR> | .. |
| 05/06/2002 10:23a | 9,277 | FileRepository.java |
| 05/06/2002 10:23a | 435 | FileRepositoryException.java |

| | |
|---|---|
| 2 File(s) | 9,712 bytes |

Directory of com\agile\sandbox\pi\fma\transformation

| | | |
|---|---|---|
| 05/06/2002 10:23a | <DIR> | . |
| 05/06/2002 10:23a | <DIR> | .. |
| 05/06/2002 10:23a | 6,682 | Formatter.java |
| 05/06/2002 10:23a | 546 | TransformationException.java |

| | |
|---|---|
| 2 File(s) | 7,228 bytes |

Directory of com\agile\sandbox\pi\fma\utils

| | | |
|---|---|---|
| 05/06/2002 10:23a | <DIR> | . |
| 05/06/2002 10:23a | <DIR> | .. |
| 05/06/2002 10:23a | 9,950 | BarChartGenerator.java |
| 05/06/2002 10:23a | 6,085 | ChartUtils.java |
| 05/06/2002 10:23a | 4,024 | DAOUtils.java |
| 05/06/2002 10:23a | 4,327 | PieChartGenerator.java |
| 05/06/2002 10:23a | 11,158 | PropertyManager.java |
| 05/06/2002 10:23a | <DIR> | test |
| 05/06/2002 10:23a | 3,812 | TimeManager.java |
| 05/06/2002 10:23a | 8,397 | Utilities.java |

| | |
|---|---|
| 7 File(s) | 47,753 bytes |

Directory of com\agile\sandbox\pi\fma\utils\test

| | | |
|---|---|---|
| 05/06/2002 10:23a | <DIR> | . |
| 05/06/2002 10:23a | <DIR> | .. |
| 05/06/2002 10:23a | 5,677 | PropertyManagerTest.java |
| 05/06/2002 10:23a | 4,066 | TimeManagerTest.java |
| 05/06/2002 10:23a | 2,746 | UtilitiesTest.java |

| | |
|---|---|
| 3 File(s) | 12,489 bytes |

Directory of com\agile\sandbox\pi\fma\view

| | | |
|---|---|---|
| 05/06/2002 10:23a | <DIR> | . |
| 05/06/2002 10:23a | <DIR> | .. |
| 05/06/2002 10:23a | 725 | DashboardException.java |
| 05/06/2002 10:23a | 34,154 | DashboardTable.java |
| 05/06/2002 10:23a | 9,362 | NavController.java |
| 05/06/2002 10:23a | 426 | NavControllerException.java |
| 05/06/2002 10:23a | 1,980 | RedirectException.java |
| 05/06/2002 10:23a | 1,125 | RedirectionController.java |
| 05/06/2002 10:23a | 2,873 | TableDescription.java |
| 05/06/2002 10:23a | 1,202 | View.java |
| 05/06/2002 10:23a | 11,164 | ViewController.java |
| 05/06/2002 10:23a | 429 | ViewControllerException.java |
| 05/06/2002 10:23a | <DIR> | web |

| | |
|---|---|
| 10 File(s) | 63,440 bytes |

Directory of com\agile\sandbox\pi\fma\view\web

| | | |
|---|---|---|
| 05/06/2002 10:23a | <DIR> | . |
| 05/06/2002 10:23a | <DIR> | .. |
| 05/06/2002 10:23a | 827 | ConfigurationException.java |
| 05/06/2002 10:23a | 7,128 | Download.java |
| 05/06/2002 10:23a | <DIR> | handler |
| 05/06/2002 10:23a | 1,868 | Help.java |
| 05/06/2002 10:23a | 10,554 | JReportWrapper.java |
| 05/06/2002 10:23a | 1,136 | Log4JController.java |
| 05/06/2002 10:23a | 4,565 | Main.java |
| 05/06/2002 10:23a | 13,929 | RedirectServlet.java |
| 05/06/2002 10:23a | 953 | RefreshQueryConfig.java |
| 05/06/2002 10:23a | 4,570 | Screen.java |
| 05/06/2002 10:23a | 30,778 | WebController.java |

| | |
|---|---|
| 10 File(s) | 76,308 bytes |

Directory of com\agile\sandbox\pi\fma\view\web\handler

| | | |
|---|---|---|
| 05/06/2002 10:23a | <DIR> | . |
| 05/06/2002 10:23a | <DIR> | .. |
| 05/06/2002 10:23a | 13,298 | CollectRequestHandler.java |
| 05/06/2002 10:23a | 9,336 | DefaultRequestHandler.java |
| 05/06/2002 10:23a | 3,217 | DistributeRequestHandler.java |
| 05/06/2002 10:23a | 31,845 | MultipartRequestHandler.java |
| 05/06/2002 10:23a | 3,512 | PortalRequestHandler.java |
| 05/06/2002 10:23a | 2,843 | ReassignRequestHandler.java |
| 05/06/2002 10:23a | 438 | RequestHandleException.java |
| 05/06/2002 10:23a | 1,496 | RequestHandler.java |
| 05/06/2002 10:23a | 5,423 | SearchRequestHandler.java |
| 05/06/2002 10:23a | 3,087 | ServiceRequestHandler.java |
| 05/06/2002 10:23a | 3,158 | SimpleSearchRequestHandler.java |
| 05/06/2002 10:23a | 731 | TodoRequestHandler.java |

| | |
|---|---|
| 12 File(s) | 78,384 bytes |

Directory of com\agile\sandbox\pi\fma\workflow

| | | |
|---|---|---|
| 05/06/2002 10:23a | <DIR> | . |
| 05/06/2002 10:23a | <DIR> | .. |
| 05/06/2002 10:23a | <DIR> | common |
| 05/06/2002 10:23a | <DIR> | dwe |
| 05/06/2002 10:23a | <DIR> | test |
| 05/06/2002 10:23a | <DIR> | wlpi |

| | |
|---|---|
| 0 File(s) | 0 bytes |

Directory of com\agile\sandbox\pi\fma\workflow\common

| | | |
|---|---|---|
| 05/06/2002 10:23a | <DIR> | . |
| 05/06/2002 10:23a | <DIR> | .. |
| 05/06/2002 10:23a | 1,982 | Assignee.java |
| 05/06/2002 10:23a | 1,033 | DepositInfo.java |
| 05/06/2002 10:23a | 4,589 | PackageInfo.java |
| 05/06/2002 10:23a | 1,140 | PackagesCache.java |
| 05/06/2002 10:23a | 5,276 | PackagesSyncThread.java |
| 05/06/2002 10:23a | 2,475 | TaskInfo.java |
| 05/06/2002 10:23a | 735 | UnsupportedWorkflowException.java |
| 05/06/2002 10:23a | 2,077 | WflnstanceInfo.java |
| 05/06/2002 10:23a | 22,138 | WorkflowAdaptor.java |
| 05/06/2002 10:23a | 10,503 | WorkflowAdminAdaptor.java |
| 05/06/2002 10:23a | 389 | WorkflowBase.java |
| 05/06/2002 10:23a | 658 | WorkflowException.java |
| 05/06/2002 10:23a | 6,607 | WorkflowFactory.java |
| 05/06/2002 10:23a | 15,761 | WorkflowHandle.java |

| | |
|---|---|
| 14 File(s) | 75,363 bytes |

Directory of com\agile\sandbox\pi\fma\workflow\dwe

| | | |
|---|---|---|
| 05/06/2002 10:23a | <DIR> | . |
| 05/06/2002 10:23a | <DIR> | .. |
| 05/06/2002 10:23a | 9,491 | ActionDriver.java |
| 05/06/2002 10:23a | 2,249 | AssignTask.java |
| 05/06/2002 10:23a | 854 | DefaultAsynchTask.java |
| 05/06/2002 10:23a | 917 | DefaultSynchTask.java |
| 05/06/2002 10:23a | 9,838 | DWEEmail.java |
| 05/06/2002 10:23a | 36,682 | WorkflowAdaptorlmpl.java |
| 05/06/2002 10:23a | 16,546 | WorkflowAdminAdaptorlmpl.java |
| 05/06/2002 10:23a | 1,885 | WorkflowAttributeSetter.java |

| | |
|---|---|
| 8 File(s) | 78,462 bytes |

Directory of com\agile\sandbox\pi\fma\workflow\test

| | | |
|---|---|---|
| 05/06/2002 10:23a | <DIR> | . |
| 05/06/2002 10:23a | <DIR> | .. |
| 05/06/2002 10:23a | 5,212 | DWEWorkflowAdminTest.java |
| 05/06/2002 10:23a | 11,516 | DWEWorkflowTest.java |
| 05/06/2002 10:23a | 4,462 | WorkflowAdminTest.java |
| 05/06/2002 10:23a | 7,581 | WorkflowTest.java |

| | |
|---|---|
| 4 File(s) | 28,771 bytes |

Directory of com\agile\sandbox\pi\fma\workflow\wlpi

| | | |
|---|---|---|
| 05/06/2002 10:23a | <DIR> | . |
| 05/06/2002 10:23a | <DIR> | .. |
| 05/06/2002 10:23a | 4,400 | MessageSender.java |
| 05/06/2002 10:23a | 1,827 | PasswordUpdate.java |
| 05/06/2002 10:23a | 1,466 | WLPIDBUtils.java |
| 05/06/2002 10:23a | 4,378 | WLPIMessageSender.java |
| 05/06/2002 10:23a | 49,194 | WorkflowAdaptorlmpl.java |
| 05/06/2002 10:23a | 23,739 | WorkflowAdminAdaptorlmpl.java |

| | |
|---|---|
| 6 File(s) | 85,004 bytes |

Directory of com\agile\sandbox\pi\logger

| | | |
|---|---|---|
| 05/06/2002 10:23a | <DIR> | . |
| 05/06/2002 10:23a | <DIR> | .. |
| 05/06/2002 10:23a | 7,642 | DailyRollingFileAppender.java |

| | |
|---|---|
| 1 File(s) | 7,642 bytes |

Directory of com\agile\sandbox\pi\notification

| | | |
|---|---|---|
| 05/06/2002 10:23a | <DIR> | . |
| 05/06/2002 10:23a | <DIR> | .. |
| 05/06/2002 10:23a | <DIR> | mail |
| 05/06/2002 10:23a | 376 | NotificationException.java |
| 05/06/2002 10:23a | 979 | Notifier.java |

| | |
|---|---|
| 2 File(s) | 1,355 bytes |

Directory of com\agile\sandbox\pi\notification\mail

| | | |
|---|---|---|
| 05/06/2002 10:23a | <DIR> | . |
| 05/06/2002 10:23a | <DIR> | .. |
| 05/06/2002 10:23a | 6,157 | Mailer.java |

| | |
|---|---|
| 1 File(s) | 6,157 bytes |

Directory of com\agile\sandbox\pi\pm

| | | |
|---|---|---|
| 05/06/2002 10:23a | <DIR> | . |
| 05/06/2002 10:23a | <DIR> | .. |
| 05/06/2002 10:23a | <DIR> | agileimport |
| 05/06/2002 10:23a | <DIR> | cleanse |
| 05/06/2002 10:23a | <DIR> | cm |
| 05/06/2002 10:23a | <DIR> | mapping |
| 05/06/2002 10:23a | 4,687 | ProcessModule.java |
| 05/06/2002 10:23a | 1,095 | ProcessModuleAlgorithmBase.java |
| 05/06/2002 10:23a | <DIR> | recognition |
| 05/06/2002 10:23a | <DIR> | reports |
| 05/06/2002 10:23a | <DIR> | standardize |
| 05/06/2002 10:23a | <DIR> | test |
| 05/06/2002 10:23a | <DIR> | util |
| 05/06/2002 10:23a | <DIR> | validate |

| | |
|---|---|
| 2 File(s) | 5,782 bytes |

Directory of com\agile\sandbox\pi\pm\agileimport

| | | |
|---|---|---|
| 05/06/2002 10:23a | <DIR> | . |
| 05/06/2002 10:23a | <DIR> | .. |
| 05/06/2002 10:23a | 4,887 | AgileImport.java |
| 05/06/2002 10:23a | 48,480 | AgileImportBase.java |
| 05/06/2002 10:23a | 9,478 | AMLImport.java |
| 05/06/2002 10:23a | 14,317 | BOMImport.java |
| 05/06/2002 10:23a | 5,406 | MfrImport.java |
| 05/06/2002 10:23a | 6,122 | MfrPartImport.java |
| 05/06/2002 10:23a | 6,372 | PartImport.java |
| 05/06/2002 10:23a | <DIR> | test |
| 05/06/2002 10:23a | <DIR> | util |

| | |
|---|---|
| 7 File(s) | 95,062 bytes |

Directory of com\agile\sandbox\pi\pm\agileimport\test

| | | |
|---|---|---|
| 05/06/2002 10:23a | <DIR> | . |
| 05/06/2002 10:23a | <DIR> | .. |
| 05/06/2002 10:23a | 4,860 | AgileAPIConstants.java |
| 05/06/2002 10:23a | 2,447 | AgileSubClassID.java |

| | |
|---|---|
| 2 File(s) | 7,307 bytes |

Directory of com\agile\sandbox\pi\pm\agileimport\util

| | | |
|---|---|---|
| 05/06/2002 10:23a | <DIR> | . |
| 05/06/2002 10:23a | <DIR> | .. |
| 05/06/2002 10:23a | 1,358 | AgileAttributes.java |
| 05/06/2002 10:23a | 890 | AgileFieldsMap.java |
| 05/06/2002 10:23a | 57,865 | AgileImportUtil.java |
| 05/06/2002 10:23a | 3,051 | DefaultAttributesMap.java |
| 05/06/2002 10:23a | 5,923 | ManufacturerPartsAttributes.java |
| 05/06/2002 10:23a | 5,574 | ManufacturersAttributes.java |
| 05/06/2002 10:23a | 9,254 | PartsAttributes.java |
| 05/06/2002 10:23a | 3,038 | SiteImportPolicy.java |
| 05/06/2002 10:23a | 6,127 | SmartRules.java |
| 05/06/2002 10:23a | <DIR> | test |

| | |
|---|---|
| 9 File(s) | 93,080 bytes |

Directory of com\agile\sandbox\pi\pm\agileimport\util\test

| | | |
|---|---|---|
| 05/06/2002 10:23a | <DIR> | . |
| 05/06/2002 10:23a | <DIR> | .. |
| 05/06/2002 10:23a | 1,744 | AgileAttributesTest.java |
| 05/06/2002 10:23a | 8,068 | AgileImportUtilTest.java |
| 05/06/2002 10:23a | 3,235 | ManufacturerPartsAttributesTest.java |
| 05/06/2002 10:23a | 3,153 | ManufacturersAttributesTest.java |
| 05/06/2002 10:23a | 4,351 | PartsAttributesTest.java |
| 05/06/2002 10:23a | 1,857 | SmartRulesTest.java |

| | |
|---|---|
| 6 File(s) | 22,408 bytes |

Directory of com\agile\sandbox\pi\pm\cleanse

| | | |
|---|---|---|
| 05/06/2002 10:23a | <DIR> | . |
| 05/06/2002 10:23a | <DIR> | .. |
| 05/06/2002 10:23a | 6,631 | CharacterRemoval.java |
| 05/06/2002 10:23a | 7,485 | Cleanse.java |
| 05/06/2002 10:23a | 3,496 | CleanseAlgorithmBase.java |
| 05/06/2002 10:23a | 754 | CleanseException.java |
| 05/06/2002 10:23a | 4,830 | RefDesExpansion.java |
| 05/06/2002 10:23a | 22,223 | ReferenceDesignator.java |
| 05/06/2002 10:23a | <DIR> | test |

| | |
|---|---|
| 6 File(s) | 45,419 bytes |

Directory of com\agile\sandbox\pi\pm\cleanse\test

| | | |
|---|---|---|
| 05/06/2002 10:23a | <DIR> | . |
| 05/06/2002 10:23a | <DIR> | .. |
| 05/06/2002 10:23a | 2,594 | CharacterRemovalTest.java |
| 05/06/2002 10:23a | 2,689 | CleanseTest.java |
| 05/06/2002 10:23a | 28,396 | ReferenceDesignatorTest.java |

| | |
|---|---|
| 3 File(s) | 33,679 bytes |

| | | |
|---|---|---|
| 05/06/2002 10:23a | <DIR> | . |
| 05/06/2002 10:23a | <DIR> | .. |
| 05/06/2002 10:23a | 16,281 | BomValidationManager.java |
| 05/06/2002 10:23a | 23,130 | CMBase.java |
| 05/06/2002 10:23a | 688 | CMStandardAlgorithm.java |
| 05/06/2002 10:23a | 9,405 | ComponentManagement.java |
| 05/06/2002 10:23a | 4,070 | ComponentManagementAsync.java |
| 05/06/2002 10:23a | <DIR> | postprocessor |
| 05/06/2002 10:23a | <DIR> | preprocessor |
| 05/06/2002 10:23a | <DIR> | rule |
| 05/06/2002 10:23a | <DIR> | test |
| 05/06/2002 10:23a | <DIR> | util |

| | |
|---|---|
| 5 File(s) | 53,574 bytes |

Directory of com\agile\sandbox\pi\pm\cm\postprocessor

| | | |
|---|---|---|
| 05/06/2002 10:23a | <DIR> | . |
| 05/06/2002 10:23a | <DIR> | .. |
| 05/06/2002 10:23a | 994 | PostProcessorBase.java |

| | |
|---|---|
| 1 File(s) | 994 bytes |

Directory of com\agile\sandbox\pi\pm\cm\preprocessor

| | | |
|---|---|---|
| 05/06/2002 10:23a | <DIR> | . |
| 05/06/2002 10:23a | <DIR> | .. |
| 05/06/2002 10:23a | 5,844 | PartTranslator.java |
| 05/06/2002 10:23a | 1,013 | PreProcessorBase.java |

| | |
|---|---|
| 2 File(s) | 6,857 bytes |

Directory of com\agile\sandbox\pi\pm\cm\rule

| | | |
|---|---|---|
| 05/06/2002 10:23a | <DIR> | . |
| 05/06/2002 10:23a | <DIR> | .. |
| 05/06/2002 10:23a | 1,733 | PartMatchRule.java |
| 05/06/2002 10:23a | 3,955 | RuleBase.java |

| | |
|---|---|
| 2 File(s) | 5,688 bytes |

Directory of com\agile\sandbox\pi\pm\cm\test

| | | |
|---|---|---|
| 05/06/2002 10:23a | <DIR> | . |
| 05/06/2002 10:23a | <DIR> | .. |
| 05/06/2002 10:23a | 2,816 | BomValidationManagerTest.java |
| 05/06/2002 10:23a | 6,966 | CMTest.java |
| 05/06/2002 10:23a | 7,732 | PartyAliasManagerTest.java |

| | |
|---|---|
| 3 File(s) | 17,514 bytes |

Directory of com\agile\sandbox\pi\pm\cm\util

| | | |
|---|---|---|
| 05/06/2002 10:23a | <DIR> | . |
| 05/06/2002 10:23a | <DIR> | .. |
| 05/06/2002 10:23a | 298 | BomBlockData.java |
| 05/06/2002 10:23a | 15,601 | BomValidationManager.java |
| 05/06/2002 10:23a | 4,000 | BomValidationRow.java |
| 05/06/2002 10:23a | 33,860 | CMAlgorithmUtil.java |
| 05/06/2002 10:23a | 5,293 | CMProfileData.java |
| 05/06/2002 10:23a | 508 | DifferentialData.java |
| 05/06/2002 10:23a | 9,056 | PartyAliasManager.java |

| | |
|---|---|
| 7 File(s) | 68,616 bytes |

Directory of com\agile\sandbox\pi\pm\mapping

| | | |
|---|---|---|
| 05/06/2002 10:23a | <DIR> | . |
| 05/06/2002 10:23a | <DIR> | .. |
| 05/06/2002 10:23a | 3,227 | DepositPartNumberGenerator.java |
| 05/06/2002 10:23a | 3,792 | MapAlgorithmBase.java |
| 05/06/2002 10:23a | 730 | MapException.java |
| 05/06/2002 10:23a | 11,167 | MapInputCriteria.java |
| 05/06/2002 10:23a | 1,664 | MapOutput.java |
| 05/06/2002 10:23a | 4,833 | Mapping.java |
| 05/06/2002 10:23a | 8,172 | MapResultGenerator.java |
| 05/06/2002 10:23a | 4,368 | PartNumberGenerator.java |
| 05/06/2002 10:23a | <DIR> | test |

| | |
|---|---|
| 8 File(s) | 37,953 bytes |

Directory of com\agile\sandbox\pi\pm\mapping\test

| | | |
|---|---|---|
| 05/06/2002 10:23a | <DIR> | . |
| 05/06/2002 10:23a | <DIR> | .. |
| 05/06/2002 10:23a | 3,025 | DepositPartNumberGeneratorTest.java |
| 05/06/2002 10:23a | 10,738 | MapResultGeneratorTest.java |

| | |
|---|---|
| 2 File(s) | 13,763 bytes |

Directory of com\agile\sandbox\pi\pm\recognition

| | | |
|---|---|---|
| 05/06/2002 10:23a | <DIR> | . |
| 05/06/2002 10:23a | <DIR> | .. |
| 05/06/2002 10:23a | 11,154 | ParserRecognition.java |
| 05/06/2002 10:23a | 3,079 | RecognitionAlgorithmBase.java |
| 05/06/2002 10:23a | 10,012 | RecognitionData.java |
| 05/06/2002 10:23a | 667 | RecognitionException.java |
| 05/06/2002 10:23a | 4,342 | StandardRecognitionAlgorithm.java |
| 05/06/2002 10:23a | <DIR> | test |

| | |
|---|---|
| 5 File(s) | 29,254 bytes |

Directory of com\agile\sandbox\pi\pm\recognition\test

| | | |
|---|---|---|
| 05/06/2002 10:23a | <DIR> | . |
| 05/06/2002 10:23a | <DIR> | .. |
| 05/06/2002 10:23a | 6,804 | ParserRecognitionTest.java |

| | |
|---|---|
| 1 File(s) | 6,804 bytes |

Directory of com\agile\sandbox\pi\pm\reports

| | | |
|---|---|---|
| 05/06/2002 10:23a | <DIR> | . |
| 05/06/2002 10:23a | <DIR> | .. |
| 05/06/2002 10:23a | 2,372 | BBIReport.java |
| 05/06/2002 10:23a | 5,059 | BRCReport.java |
| 05/06/2002 10:23a | 2,395 | DellAMLReport.java |
| 05/06/2002 10:23a | 2,394 | DellBOMReport.java |
| 05/06/2002 10:23a | 17,531 | FileDiffReport.java |
| 05/06/2002 10:23a | 8,266 | getRptDescPage2.jsp |
| 05/06/2002 10:23a | 10,087 | JNIExcelCopier.java |
| 05/06/2002 10:23a | 8,420 | JReportAlgorithm.java |
| 05/06/2002 10:23a | 11,114 | JReportServer.java |
| 05/06/2002 10:23a | 6,302 | KludgeExactMatchReport.java |
| 05/06/2002 10:23a | 9,647 | OutputReport.java |
| 05/06/2002 10:23a | 20,791 | PartCountReport.java |
| 05/06/2002 10:23a | 2,364 | PDXReport.java |
| 05/06/2002 10:23a | 8,194 | ReportAlgorithmBase.java |
| 05/06/2002 10:23a | 778 | ReportException.java |
| 05/06/2002 10:23a | 3,551 | runReport2.jsp |
| 05/06/2002 10:23a | <DIR> | test |

| | |
|---|---|
| 16 File(s) | 119,265 bytes |

Directory of com\agile\sandbox\pi\pm\reports\test

| | | |
|---|---|---|
| 05/06/2002 10:23a | <DIR> | . |
| 05/06/2002 10:23a | <DIR> | .. |
| 05/06/2002 10:23a | 2,963 | BBIReportTest.java |
| 05/06/2002 10:23a | 2,258 | JNIExcelCopierTest.java |
| 05/06/2002 10:23a | 3,763 | OutputReportTest.java |

| | |
|---|---|
| 3 File(s) | 8,984 bytes |

Directory of com\agile\sandbox\pi\pm\standardize

| | | |
|---|---|---|
| 05/06/2002 10:23a | <DIR> | . |
| 05/06/2002 10:23a | <DIR> | .. |
| 05/06/2002 10:23a | 59,298 | CachedMergerAlgorithm.java |
| 05/06/2002 10:23a | 3,913 | CustomParserAlgorithm.java |
| 05/06/2002 10:23a | 71,251 | ParserAlgorithmBase.java |
| 05/06/2002 10:23a | <DIR> | postprocessor |
| 05/06/2002 10:23a | <DIR> | preprocessor |
| 05/06/2002 10:23a | 14,331 | Standardize.java |
| 05/06/2002 10:23a | 1,183 | StandardizeException.java |
| 05/06/2002 10:23a | 53,265 | StandardMergerAlgorithm.java |
| 05/06/2002 10:23a | 9,309 | StandardParser.java |
| 05/06/2002 10:23a | 19,889 | StandardParserAlgorithm.java |
| 05/06/2002 10:23a | <DIR> | submodule |
| 05/06/2002 10:23a | <DIR> | test |
| 05/06/2002 10:23a | <DIR> | util |

| | |
|---|---|
| 8 File(s) | 232,439 bytes |

Directory of com\agile\sandbox\pi\pm\standardize\postprocessor

| | | |
|---|---|---|
| 05/06/2002 10:23a | <DIR> | . |
| 05/06/2002 10:23a | <DIR> | .. |
| 05/06/2002 10:23a | 13,049 | BomLevelAssembler.java |
| 05/06/2002 10:23a | 12,108 | BomPartDetailMerger.java |
| 05/06/2002 10:23a | 4,441 | CharacterRemoval.java |
| 05/06/2002 10:23a | 4,177 | FieldAppender.java |
| 05/06/2002 10:23a | 446 | PostProcessorBase.java |
| 05/06/2002 10:23a | 3,692 | RefDesPostExpander.java |

| | |
|---|---|
| 6 File(s) | 37,913 bytes |

Directory of com\agile\sandbox\pi\pm\standardize\preprocessor

| | | |
|---|---|---|
| 05/06/2002 10:23a | <DIR> | . |
| 05/06/2002 10:23a | <DIR> | .. |
| 05/06/2002 10:23a | 3,325 | DocToTxtConverter.java |
| 05/06/2002 10:23a | 6,446 | ExcelToTxtConverter.java |
| 05/06/2002 10:23a | 3,781 | HSSFToTextConverter.java |
| 05/06/2002 10:23a | 2,285 | HtmlToTxtConverter.java |
| 05/06/2002 10:23a | 2,843 | NonBreakingSpaceConverter.java |
| 05/06/2002 10:23a | 2,518 | PdfToTxtConverter.java |
| 05/06/2002 10:23a | 6,294 | PdxToTxtConverter.java |
| 05/06/2002 10:23a | 2,284 | PreProcessorBase.java |
| 05/06/2002 10:23a | 5,288 | TLAHeaderMover.java |

| | |
|---|---|
| 9 File(s) | 35,064 bytes |

Directory of com\agile\sandbox\pi\pm\standardize\submodule

| | | |
|---|---|---|
| 05/06/2002 10:23a | <DIR> | . |
| 05/06/2002 10:23a | <DIR> | .. |
| 05/06/2002 10:23a | 4,004 | AvlFieldExtractor.java |
| 05/06/2002 10:23a | 3,129 | BomFieldDiverter.java |
| 05/06/2002 10:23a | 5,412 | BomFieldExtractor.java |
| 05/06/2002 10:23a | 3,999 | BomFieldReplacer.java |
| 05/06/2002 10:23a | 2,527 | DuplicatedVendorsRemover.java |
| 05/06/2002 10:23a | 3,487 | FieldMerger.java |
| 05/06/2002 10:23a | 3,421 | FieldMultiPatternExtractor.java |
| 05/06/2002 10:23a | 1,635 | FirstVPNAsPN.java |
| 05/06/2002 10:23a | 4,463 | ParserSubModuleBase.java |
| 05/06/2002 10:23a | 2,225 | PartNumberCleaner.java |
| 05/06/2002 10:23a | 4,990 | PreviousFieldRetriever.java |
| 05/06/2002 10:23a | 5,089 | QuantityCalculator.java |
| 05/06/2002 10:23a | 1,920 | QuantityUOMSplitter.java |
| 05/06/2002 10:23a | 3,606 | RefDesCleaner.java |
| 05/06/2002 10:23a | 1,943 | RefDesExpander.java |
| 05/06/2002 10:23a | 4,735 | RefDesFilter.java |
| 05/06/2002 10:23a | 7,271 | VendorDataCopierA.java |
| 05/06/2002 10:23a | 6,367 | VendorDataCopierB.java |
| 05/06/2002 10:23a | 2,475 | VendorDataDuplicater.java |
| 05/06/2002 10:23a | 1,969 | VendorDataMerger.java |
| 05/06/2002 10:23a | 9,272 | VendorDataSplitter.java |
| 05/06/2002 10:23a | 2,174 | VendorPartNumberReplacer.java |

| | |
|---|---|
| 22 File(s) | 86,113 bytes |

Directory of com\agile\sandbox\pi\pm\standardize\test

| | | |
|---|---|---|
| 05/06/2002 10:23a | <DIR> | . |
| 05/06/2002 10:23a | <DIR> | .. |
| 05/06/2002 10:23a | 7,627 | StandardizeTest.java |
| 05/06/2002 10:23a | 14,135 | StandardParserTest.java |

| | |
|---|---|
| 2 File(s) | 21,762 bytes |

Directory of com\agile\sandbox\pi\pm\standardize\util

| | | |
|---|---|---|
| 05/06/2002 10:23a | <DIR> | . |
| 05/06/2002 10:23a | <DIR> | .. |
| 05/06/2002 10:23a | 637 | BlockIndicatorData.java |
| 05/06/2002 10:23a | 1,233 | MergerProfileData.java |
| 05/06/2002 10:23a | 17,837 | ParserAlgorithmUtil.java |
| 05/06/2002 10:23a | 1,510 | ParserDifferenceData.java |
| 05/06/2002 10:23a | 2,911 | ParserErrorData.java |
| 05/06/2002 10:23a | 30,421 | ParserProfileData.java |
| 05/06/2002 10:23a | 1,336 | ParserSelectOneREVGlobalSeq.java |
| 05/06/2002 10:23a | 3,947 | PmBomPartDetailsClass.java |
| 05/06/2002 10:23a | 6,403 | PmObjectCopier.java |
| 05/06/2002 10:23a | 2,979 | PmObjectSaver.java |
| 05/06/2002 10:23a | 3,946 | PmPartVendorMapsClass.java |
| 05/06/2002 10:23a | 4,758 | TLA.java |

| | |
|---|---|
| 12 File(s) | 77,918 bytes |

Directory of com\agile\sandbox\pi\pm\test

| | | |
|---|---|---|
| 05/06/2002 10:23a | <DIR> | . |
| 05/06/2002 10:23a | <DIR> | .. |
| 05/06/2002 10:23a | 3,630 | pmTest.java |

| | |
|---|---|
| 1 File(s) | 3,630 bytes |

Directory of com\agile\sandbox\pi\pm\util

| | | |
|---|---|---|
| 05/06/2002 10:23a | <DIR> | . |
| 05/06/2002 10:23a | <DIR> | .. |
| 05/06/2002 10:23a | 1,760 | AlgorithmProfileData.java |
| 05/06/2002 10:23a | 4,452 | Base32.java |
| 05/06/2002 10:23a | 26,074 | BBIGenerator.java |
| 05/06/2002 10:23a | 2,881 | BBIToExcel.java |
| 05/06/2002 10:23a | 719 | BomBlock.java |
| 05/06/2002 10:23a | 8,246 | BOMPackage.java |
| 05/06/2002 10:23a | 781 | BOMPackageException.java |
| 05/06/2002 10:23a | 9,082 | Constants.java |
| 05/06/2002 10:23a | 2,376 | CSVStringlterator.java |
| 05/06/2002 10:23a | <DIR> | datasource |
| 05/06/2002 10:23a | 739 | DBSelectOneREVGlobalSeq.java |
| 05/06/2002 10:23a | 1,906 | DBUtils.java |
| 05/06/2002 10:23a | 14,468 | DellGenerator.java |
| 05/06/2002 10:23a | 2,506 | FileLocator.java |
| 05/06/2002 10:23a | 3,768 | FileTypeUtils.java |
| 05/06/2002 10:23a | 2,397 | FileUtils.java |
| 05/06/2002 10:23a | 14,575 | FrameworkUtils.java |
| 05/06/2002 10:23a | 10,624 | ParserUtils.java |
| 05/06/2002 10:23a | 15,487 | PDXGenerator.java |
| 05/06/2002 10:23a | 1,450 | PMErrorNotification.java |
| 05/06/2002 10:23a | 15,468 | ProcessorUtils.java |
| 05/06/2002 10:23a | <DIR> | test |
| 05/06/2002 10:23a | 757 | ThreadRunnable.java |
| 05/06/2002 10:23a | 3,813 | ThreadUtils.java |
| 05/06/2002 10:23a | 780 | VendorBlock.java |

| | |
|---|---|
| 23 File(s) | 145,109 bytes |

Directory of com\agile\sandbox\pi\pm\util\datasource

| | | |
|---|---|---|
| 05/06/2002 10:23a | <DIR> | . |
| 05/06/2002 10:23a | <DIR> | .. |
| 05/06/2002 10:23a | <DIR> | arrow |
| 05/06/2002 10:23a | 11,515 | ArrowDataSource.java |
| 05/06/2002 10:23a | 1,395 | DataSourceBase.java |
| 05/06/2002 10:23a | 8,548 | DataSourceConfiguration.java |
| 05/06/2002 10:23a | 6,169 | JDBCDataSource.java |
| 05/06/2002 10:23a | 8,427 | ReferenceArrow.java |
| 05/06/2002 10:23a | 3,251 | ReferenceData.java |
| 05/06/2002 10:23a | 12,935 | ReferenceJDBC.java |
| 05/06/2002 10:23a | 4,681 | ReferenceSOAP.java |
| 05/06/2002 10:23a | 30,085 | SOAPDataSource.java |

| | |
|---|---|
| 9 File(s) | 87,006 bytes |

Directory of com\agile\sandbox\pi\pm\util\datasource\arrow

| | | |
|---|---|---|
| 05/06/2002 10:23a | <DIR> | . |
| 05/06/2002 10:23a | <DIR> | .. |
| 05/06/2002 10:23a | 4,768 | Exception.java |
| 05/06/2002 10:23a | 12,800 | Https_Arrow_Web_Service_ComBindingStub.java |
| 05/06/2002 10:23a | 535 | Https_Arrow_Web_Service_ComPortType.java |
| 05/06/2002 10:23a | 750 | Https_Arrow_Web_Service_ComService.java |
| 05/06/2002 10:23a | 4,738 | Https_Arrow_Web_Service_ComServiceLocator.java |
| 05/06/2002 10:23a | 3,904 | Manufacturer.java |
| 05/06/2002 10:23a | 7,967 | MarketInformationReqStructArrayItem.java |
| 05/06/2002 10:23a | 7,774 | MarketInformationRequestMoreParam.java |
| 05/06/2002 10:23a | 5,916 | MarketInformationResponse.java |
| 05/06/2002 10:23a | 6,852 | MarketInformationResStructArrayItem.java |
| 05/06/2002 10:23a | 10,662 | MarketPartInfoArrayItem.java |
| 05/06/2002 10:23a | 5,441 | PriceAvailInfo.java |
| 05/06/2002 10:23a | 4,017 | PriceBreakArrayItem.java |
| 05/06/2002 10:23a | 7,603 | RiskInfo.java |
| 05/06/2002 10:23a | 4,857 | UserAuth.java |

| | |
|---|---|
| 15 File(s) | 88,584 bytes |

| | | |
|---|---|---|
| 05/06/2002 10:23a | <DIR> | . |
| 05/06/2002 10:23a | <DIR> | .. |
| 05/06/2002 10:23a | 2,572 | BOMPackageTest.java |
| 05/06/2002 10:23a | 2,340 | DBUtilsTest.java |
| 05/06/2002 10:23a | 2,051 | FileUtilsTest.java |
| 05/06/2002 10:23a | 3,447 | FrameworkUtilsTest.java |

| | |
|---|---|
| 4 File(s) | 10,410 bytes |

Directory of com\agile\sandbox\pi\pm\validate

| | | |
|---|---|---|
| 05/06/2002 10:23a | <DIR> | . |
| 05/06/2002 10:23a | <DIR> | .. |
| 05/06/2002 10:23a | 29,188 | AgileFieldsValidation.java |
| 05/06/2002 10:23a | 5,833 | AgileValidationBase.java |
| 05/06/2002 10:23a | 2,087 | CreateItemCheck.java |
| 05/06/2002 10:23a | 2,856 | CreateMfrCheck.java |
| 05/06/2002 10:23a | 2,864 | CreateMfrPartCheck.java |
| 05/06/2002 10:23a | 4,648 | DuplicateFindNumber.java |
| 05/06/2002 10:23a | 6,799 | DuplicatePartNumber.java |
| 05/06/2002 10:23a | 5,564 | DuplicateRefDes.java |
| 05/06/2002 10:23a | 5,827 | DuplicateVPN.java |
| 05/06/2002 10:23a | 3,811 | IdenticalParentChild.java |
| 05/06/2002 10:23a | 4,385 | InvalidQuantity.java |
| 05/06/2002 10:23a | 3,397 | ItemRevisionCheck.java |
| 05/06/2002 10:23a | 3,339 | MissingDescription.java |
| 05/06/2002 10:23a | 3,280 | MissingLevel.java |
| 05/06/2002 10:23a | 3,324 | MissingPartNumber.java |
| 05/06/2002 10:23a | 3,300 | MissingQuantity.java |
| 05/06/2002 10:23a | 3,276 | MissingRefDes.java |
| 05/06/2002 10:23a | 3,276 | MissingUOM.java |
| 05/06/2002 10:23a | 3,360 | MissingVendorName.java |
| 05/06/2002 10:23a | 3,385 | MissingVendorPartNumber.java |
| 05/06/2002 10:23a | 3,641 | MissingVendorPartPreferredStatus.java |
| 05/06/2002 10:23a | 3,540 | MissingVendorPartRemarks.java |
| 05/06/2002 10:23a | 3,521 | MissingVendorPartStatus.java |
| 05/06/2002 10:23a | 3,966 | MissingVendorStatus.java |
| 05/06/2002 10:23a | 3,622 | ModifyItemCheck.java |
| 05/06/2002 10:23a | 3,696 | ModifyMfrCheck.java |
| 05/06/2002 10:23a | 3,876 | ModifyMfrPartCheck.java |
| 05/06/2002 10:23a | 5,593 | MultDescription.java |
| 05/06/2002 10:23a | 1,906 | MultipleItemRevisions.java |
| 05/06/2002 10:23a | 10,817 | MultipleItemsPerMfrPartCheck.java |
| 05/06/2002 10:23a | 3,487 | PendingECOCheck.java |
| 05/06/2002 10:23a | 3,596 | PendingMCOCheck.java |
| 05/06/2002 10:23a | 8,786 | QtyRefDesMismatch.java |
| 05/06/2002 10:23a | 2,503 | RecursiveBOMCheck.java |
| 05/06/2002 10:23a | 2,772 | RedLineAMLOnPrelimItemCheck.java |
| 05/06/2002 10:23a | 2,924 | RedLineOnPrelimItemCheck.java |
| 05/06/2002 10:23a | 1,902 | SimpleSQLValidateAlgorithmBase.java |
| 05/06/2002 10:23a | 1,707 | SQLValidateAlgorithmBase.java |
| 05/06/2002 10:23a | <DIR> | test |
| 05/06/2002 10:23a | 4,236 | UnusualPartNumber.java |
| 05/06/2002 10:23a | 4,988 | UnusualVendorPartNumber.java |
| 05/06/2002 10:23a | 13,364 | Validate.java |
| 05/06/2002 10:23a | 14,052 | ValidateAlgorithmBase.java |
| 05/06/2002 10:23a | 803 | ValidateException.java |

| | |
|---|---|
| 43 File(s) | 213,097 bytes |

Directory of com\agile\sandbox\pi\pm\validate\test

| | | |
|---|---|---|
| 05/06/2002 10:23a | <DIR> | . |
| 05/06/2002 10:23a | <DIR> | .. |
| 05/06/2002 10:23a | 3,362 | AgileFieldsValidationTest.java |
| 05/06/2002 10:23a | 2,655 | ValidateTest.java |

| | |
|---|---|
| 2 File(s) | 6,017 bytes |

Directory of com\agile\sandbox\pi\qa

| | | |
|---|---|---|
| 05/06/2002 10:23a | <DIR> | . |
| 05/06/2002 10:23a | <DIR> | .. |
| 05/06/2002 10:23a | <DIR> | browser |
| 05/06/2002 10:23a | <DIR> | common |
| 05/06/2002 10:23a | <DIR> | eventhandlers |
| 05/06/2002 10:23a | <DIR> | events |
| 05/06/2002 10:23a | <DIR> | fma |
| 05/06/2002 10:23a | <DIR> | model |
| 05/06/2002 10:23a | <DIR> | pm |
| 05/06/2002 10:23a | 3,143 | QAAlgorithmBase.java |
| 05/06/2002 10:23a | 4,341 | QACheck.java |
| 05/06/2002 10:23a | <DIR> | system |
| 05/06/2002 10:23a | <DIR> | util |

| | |
|---|---|
| 2 File(s) | 7,484 bytes |

Directory of com\agile\sandbox\pi\qa\browser

| | | |
|---|---|---|
| 05/06/2002 10:23a | <DIR> | . |
| 05/06/2002 10:23a | <DIR> | .. |
| 05/06/2002 10:23a | 4,317 | BrowserVersion.java |
| 05/06/2002 10:23a | 1,096 | QABrowserBase.java |

| | |
|---|---|
| 2 File(s) | 5,413 bytes |

Directory of com\agile\sandbox\pi\qa\common

| | | |
|---|---|---|
| 05/06/2002 10:23a | <DIR> | . |
| 05/06/2002 10:23a | <DIR> | .. |
| 05/06/2002 10:23a | 696 | QAConstants.java |

| | |
|---|---|
| 1 File(s) | 696 bytes |

Directory of com\agile\sandbox\pi\qa\eventhandlers

| | | |
|---|---|---|
| 05/06/2002 10:23a | <DIR> | . |
| 05/06/2002 10:23a | <DIR> | .. |
| 05/06/2002 10:23a | 1,614 | CreateModuleEH.java |
| 05/06/2002 10:23a | 2,332 | ModuleTestEH.java |

| | |
|---|---|
| 2 File(s) | 3,946 bytes |

Directory of com\agile\sandbox\pi\qa\events

| | | |
|---|---|---|
| 05/06/2002 10:23a | <DIR> | . |
| 05/06/2002 10:23a | <DIR> | .. |
| 05/06/2002 10:23a | 2,360 | ModuleTestEvent.java |

| | |
|---|---|
| 1 File(s) | 2,360 bytes |

Directory of com\agile\sandbox\pi\qa\fma

| | | |
|---|---|---|
| 05/06/2002 10:23a | <DIR> | . |
| 05/06/2002 10:23a | <DIR> | .. |
| 05/06/2002 10:23a | 2,257 | LostPackage.java |
| 05/06/2002 10:23a | 707 | QAFmaBase.java |
| 05/06/2002 10:23a | 17,423 | UserRoleSync.java |
| 05/06/2002 10:23a | 7,564 | UserTailoredView.java |

| | |
|---|---|
| 4 File(s) | 27,951 bytes |

Directory of com\agile\sandbox\pi\qa\model

| | | |
|---|---|---|
| 05/06/2002 10:23a | <DIR> | . |
| 05/06/2002 10:23a | <DIR> | .. |
| 05/06/2002 10:23a | 17,468 | CreateModuleModel.java |
| 05/06/2002 10:23a | 15,792 | ModuleTestModel.java |

| | |
|---|---|
| 2 File(s) | 33,260 bytes |

Directory of com\agile\sandbox\pi\qa\pm

| | | |
|---|---|---|
| 05/06/2002 10:23a | <DIR> | . |
| 05/06/2002 10:23a | <DIR> | .. |
| 05/06/2002 10:23a | 8,784 | ParserRecognition.java |
| 05/06/2002 10:23a | 691 | QAPmBase.java |

| | |
|---|---|
| 2 File(s) | 9,475 bytes |

Directory of com\agile\sandbox\pi\qa\system

| | | |
|---|---|---|
| 05/06/2002 10:23a | <DIR> | . |
| 05/06/2002 10:23a | <DIR> | .. |
| 05/06/2002 10:23a | 2,104 | DBConnect.java |
| 05/06/2002 10:23a | 5,833 | DiskSpace.java |
| 05/06/2002 10:23a | 3,261 | DpstDtlsSequenceValue.java |
| 05/06/2002 10:23a | 2,966 | DpstSequenceValue.java |
| 05/06/2002 10:23a | 3,154 | GrDpstDtlsSequenceValue.java |
| 05/06/2002 10:23a | 2,842 | JREMemory.java |
| 05/06/2002 10:23a | 3,088 | PrcInstSequenceValue.java |
| 05/06/2002 10:23a | 913 | QASystemBase.java |

| | |
|---|---|
| 8 File(s) | 24,161 bytes |

Directory of com\agile\sandbox\pi\qa\util

| | | |
|---|---|---|
| 05/06/2002 10:23a | <DIR> | . |
| 05/06/2002 10:23a | <DIR> | .. |
| 05/06/2002 10:23a | 4,136 | QAParams.java |

| | |
|---|---|
| 1 File(s) | 4,136 bytes |

Total Files Listed:

| | |
|---|---|
| 1113 File(s) | 11,292,983 bytes |
| 308 Dir(s) | 3,413,372,928 bytes free |

### BACKGROUND OF THE INVENTION

Many systems rely on interpreting, parsing, and normalizing information from sources that have variable data patterns, formats, and notations for the information. In such cases, new programs have to be written on a case-by-case basis to interpret the information. Parsers, specific to the data patterns in the file, have to be written. In general cases, a new parser has to be written to interpret the same information if any aspect of the pattern is changed. For example, if the information in a new file is separated by a comma instead of a tab, a new parser will have to be written. In case of mission-critical business processes and system, this places a severe constraint and risk on the system. These modules are written in time constraints, hence the quality of the module is always of a concern. More importantly, these modules cannot even take a slight variation in the format (a new parser will have to be written). In addition, in a general case, human intervention is required to determine which module can interpret the given pattern of information. As a result, vast amount of resources are consumed. This is especially true for Enterprise Resource Planning (ERP) systems where a vendor has to accept Bill Of Materials (BOMS), which is an aggregation of part information, in multiple formats from different vendors. In such cases, processing the same information but in variable formats becomes a bottleneck in providing the service.

The manufacturing bill of material (BOM) files contains various information such as part number, revision, reference designator. Usually they are generated from computers. They come with various format, such as excel file, plain text file, pdf file, and xml file. These files can all be converted to plain text file. Further, these files also contains various discernible repeated structure. We call these structure as blocks. But different files from different sources may or may not have the same block structure. In order to process these files efficiently, we need to get pieces of information from these files, and save them into database. Current practice is to write a separate BOM parser for each new type of BOM file. This results in high cost of parser development and maintenance.

Thus, there is a need to automate the process to recognize, parse and normalize data pattern based information.

### SUMMARY OF THE INVENTION

In the present invention, a method of recognizing and normalizing repeatable data pattern from a file using a computer executing a computer program comprises receiving the file. The program then recognizes the data pattern of the file based upon a profile selected from a plurality of profiles from a library. The file is parsed into a plurality of data fields based upon the profile selected. The parsed data is then stored in a database. The present invention also relates to an article of manufacturing comprising a computer usable medium having computer readable program code embodied therein configured to perform the foregoing described method. Finally, the present invention comprises a computer system with a computer and a computer program to execute the foregoing method.

The present invention also relates to a method of dynamically increasing the accuracy of recognizing and normalizing repeatable data pattern from a file using a computer executing a computer program. The file is received. The data pattern is recognized based upon a profile selected from a plurality of profiles from a library. The file is parsed into a plurality of data fields in the event the data pattern of the file is recognizable based upon the profile selected. In the event the computer program is unable to recognize the data pattern based upon any of the plurality of profiles from the library, then a user is notified. The computer program receives a new profile of the file into the library based upon manually inputted profile. The present invention also relates to an article of manufacturing comprising a computer usable medium having computer readable program code embodied therein configured to perform the foregoing described method. Finally, the present invention comprises a computer system with a computer and a computer program to execute the foregoing method.

### BRIEF DESCRIPTION OF THE DRAWINGS

FIG. 1 is a flow chart of the method of the present invention.

FIG. 2 is an example of a first type of BOM file having data pattern information which the present invention is able to recognize and normalize.

FIGS. 3a and 3b is an example of a second type of BOM file having data pattern information which the present invention is able to recognize and normalize.

FIGS. 4a and 4b is an example of a third type of BOM file having data pattern information which the present invention is able to recognize and normalize.

FIG. 5 is an enlarged view of a portion of the second type of BOM file shown in FIGS. 3a and 3b showing how the recognition and parsing portion of the method of the present invention operates.

FIG. 6 is an example of a database with associated information for a particular profile to determine the location of the data pattern where the information can be extracted.

### DETAILED DESCRIPTION OF THE INVENTION

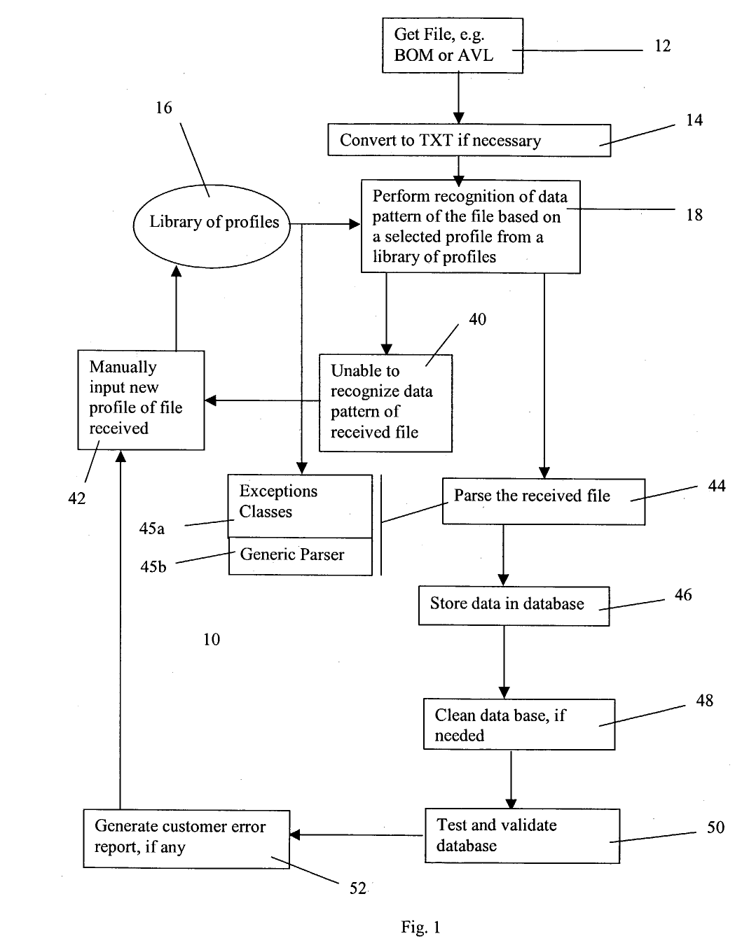

Referring to FIG. 1 there is shown a flow chart 10 of the method of the present invention. In the preferred embodiment, the present invention is embodied as a computer program whose program files are set forth on a computer program listing appendix which is on a Compact Disc Recordable (CD-R) media which is incorporated by reference herein. The present invention is a method, as well as an article of manufacturing comprising a computer usable medium having computer readable program code embodied therein configured to perform the method. Finally, the present invention also comprises a computer system with a computer (not shown) and a computer program (as set forth in the CD-R) to execute the method.

In the preferred method of the present invention, a file, such as a Bill of Materials (BOM) file or an Approved Vendor List (AVL) file (also known as an Approved Manufacturer List (AML) file) is received, in block 12. All of these types of files are characterized by a data pattern having repeatable information. Collectively, hereinafter, all of these files will be referred to as BOM files. Further, because these BOM files are generated from different sources, e.g. sources using different computer programs, the type of file and the nature of the data pattern will differ. Thus, files can be generated as text files (with extension of TXT), or as spread sheet file (with extension of XLS) or Adobe Portable Document File (with extension of PDF), or HyperText Mark-up Language (with extension of HTML), the received BOM file is first converted into a TXT file, if needed. Further, even if files were generated with the same extension, the delimiter, or marker which separates the data pattern into repeatable sections may differ. Thus, one source may use a delimiter of a tab while another source may use a delimiter of a space with in an XLS file.

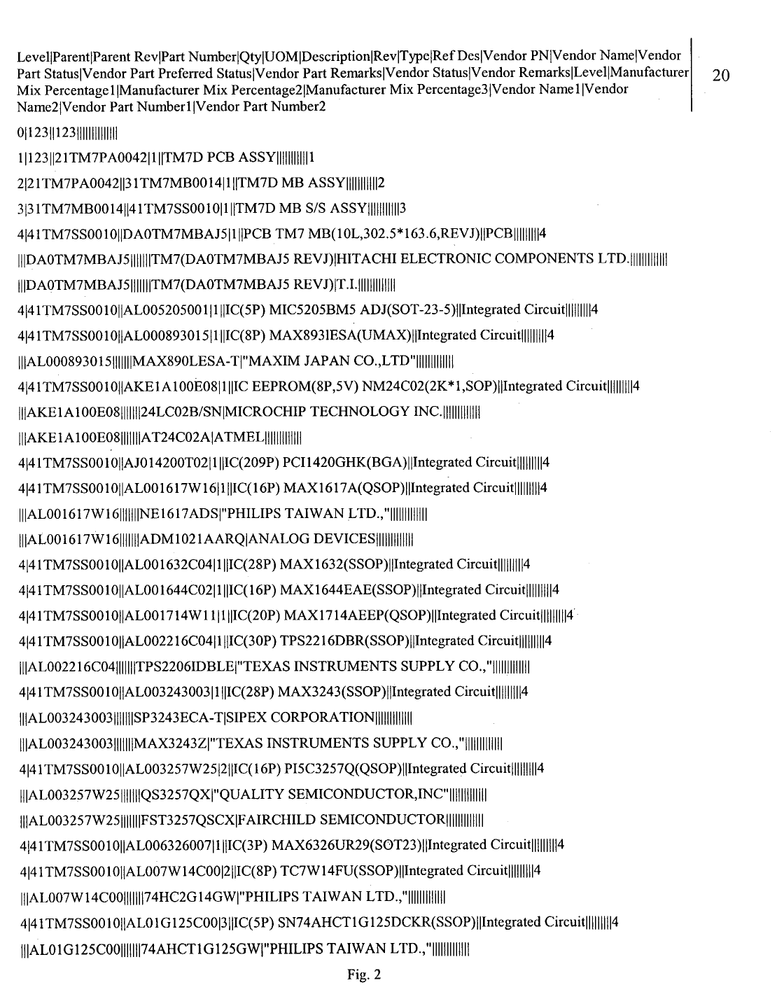

Referring to FIG. 2 there is shown a first example of a type of BOM file that is created by a first source, and can be processed by the present invention. In this example, the simplest example, the BOM file is in TXT or text format. Further, the BOM file begins with a header portion designated 20 which indicates the type of data which is repeated. The header is a portion of a characteristic of a file called a “profile”. Thus, the header 20 consists of ““Level”, “Parent”, “Parent Rev” etc. ending with “Vendor Part Number2”. Further, the delimiter is the symbol “|”. In this example, the data identified as “Part Number” is the fourth entry in the header field 20. For the data that corresponds to “Part Number”, these would be the data entries of “123” (2nd entry) in the first line after the header 20, “21TM7PA0042” in the second line after the header 20, and “31TM7 MB0014” in the third line after the header 20, etc.

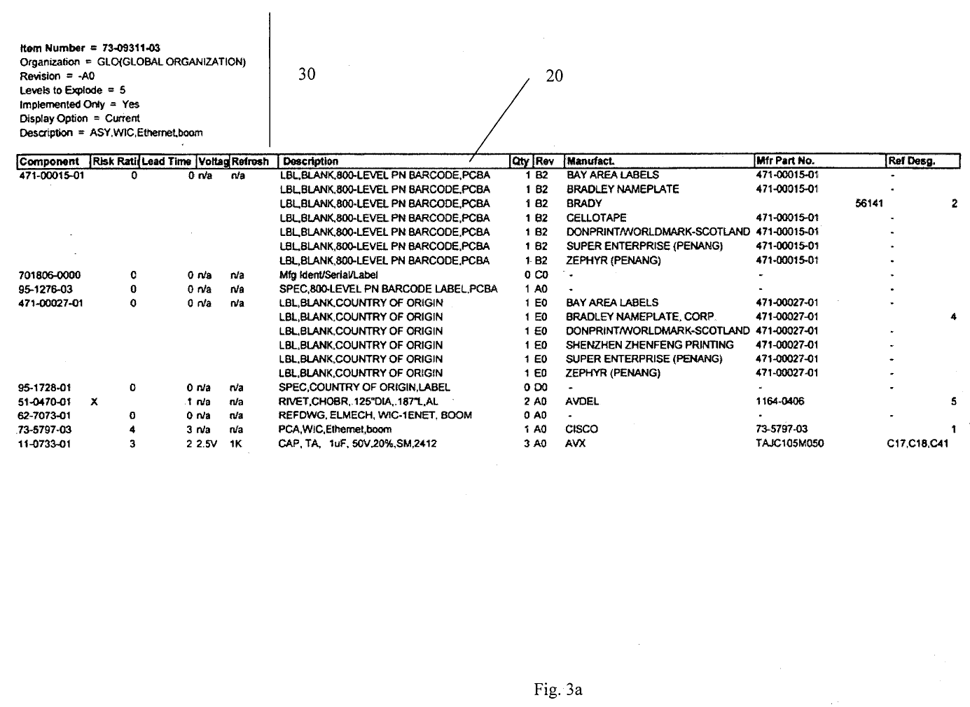

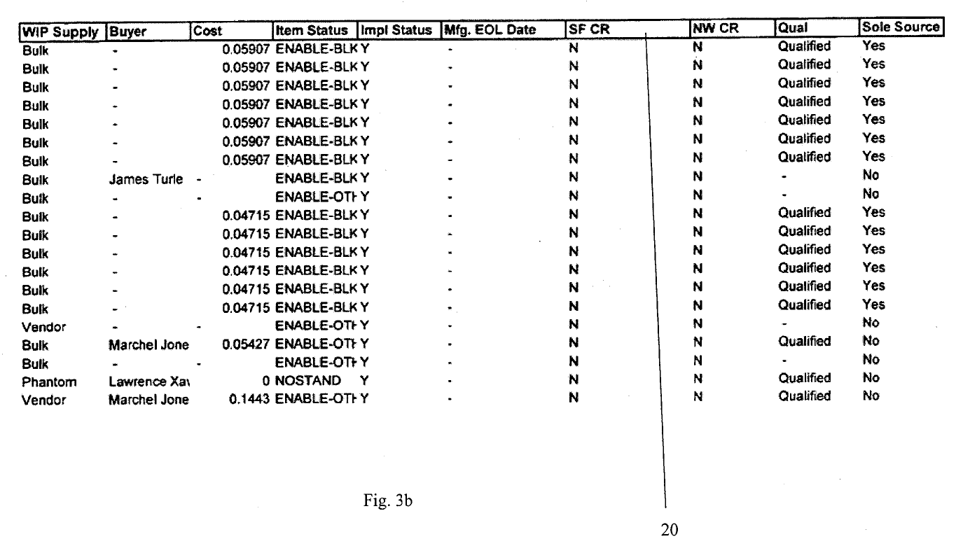

Referring to FIG. 3(a&b), there is shown a second example of a type of BOM file that is created by a second source and which can be processed by the present invention. In the example shown in FIG. 3(a&b), the BOM file is in XLS or spread sheet format. The BOM file starts with a portion 30 which is not repeated data pattern, and is deemed “Junk”. The header 20 consists of “title” to the columns of data. In the example shown in FIG. 3(a&b), the spread sheet extends over 21 columns, starting with the column entitled “Component” (in FIG. 3a) and ending with the column entitled “Sole Source” (in FIG. 3b). Because this is an XLS file, the delimiter can be a tab, or any other character, depending upon how the file was created. The data pattern “fills” a number of rows. Thus, the first repeated data pattern fills 7 rows, while the second repeated data pattern fills 1 row. Each of such repeated data pattern is termed a “block”. Thus, a block is identified by coordinates, such as upper left column, lower left column, and number of columns.

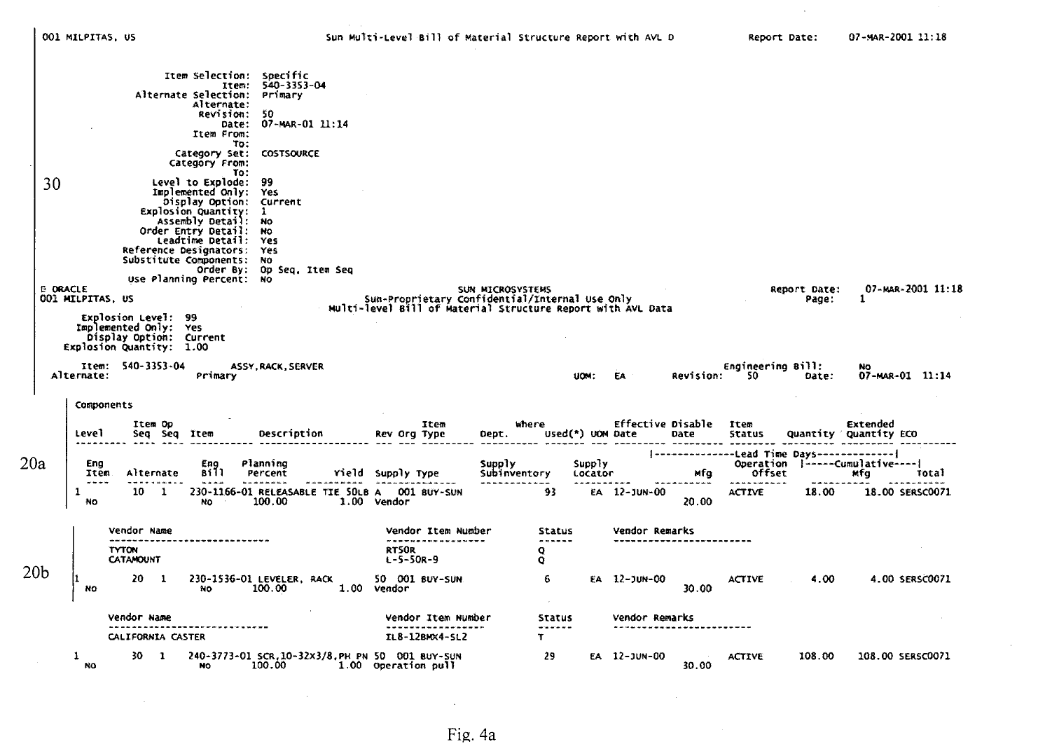

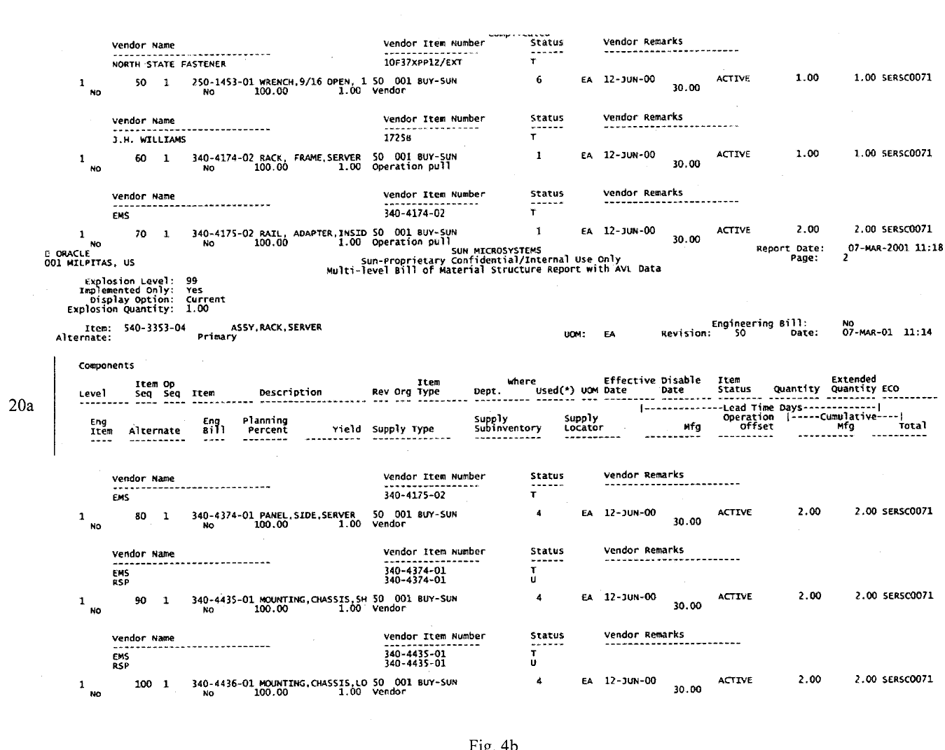

Referring to FIG. 4(a&b), there is shown a third example of a type of BOM file that is created by a third source and which can be processed by the present invention. In the example shown in FIG. 4(a&b), the BOM file again is in TXT or text format. However, the BOM file, similar to the example shown in FIG. 3(a&b) begins with a large portion which is “junk” 30 and is not repeated data pattern. The header 20 comprises two nested headers 20a and 20b. Header 20a comprises the heading “Components” “Level1” “Item Seq” etc. This is repeated in FIGS. 4a and 4b. The header 20b is nested within the header 20a, and it comprises “Vendor Name”, “Vendor Item Number”, “Status”, and “Vendor Remarks.” The delimiter can be a space or a tab.

Referring back to FIG. 1, as previously stated, in the present invention the BOM file is first received by Block 12, and is converted into a TXT file, if needed by block 14, designated hereinafter as a “converted” BOM file.

The “converted” BOM file is then scanned to determine if the header 20 in the “converted” BOM file matches the header 20 from a library of profiles 16, by a recognition engine 18. This process is accomplished by attempting to match each of the headers 20 stored in the library 16 with the text scanned in the “converted” BOM file. Thus, for example, if the received file is the second example shown in FIG. 3(a&b), the recognition engine 18 retrieves each of the headers stored in the library 16 and compares the header from the library 16 with the header scanned by the engine to the second example. For example, one of the headers stored in the library 16 might be the header consisting of “Level|Parent|Parent Rev|Part Number . . . ” from the header shown in FIG. 2. This header is compared to the text from the “converted” BOM file to attempt to find a match. Clearly in this case, if the “converted” BOM file is the second example shown in FIG. 3(a&b), there would not be a match. Another header that might be stored in the library 16 is the header consisting of “Component” “Risk Ratio” “Lead Time” etc. Matching this header to the “converted” BOM file, one would find a match between the second example shown in the FIG. 3(a&b) and the header from the library 16.

Because initially the library 16 may have only a few well known and used headers, there is a good chance that there might not be a match between the header from the library 16 and the “converted” BOM file. In that event, there would be an inability by the recognition engine 18 to find a match between the header of the “converted” BOM file and any of the headers from the library 16. In the event the recognition engine 18 is unable to find a match at block 40, the administrator is notified at block 42 and is prompted to enter a new profile (which as will be explained, consists of header information and other information) which represents the profile of the “converted” BOM file. The new profile is entered into the library 16.

As can be seen by this method, as new headers are encountered which are not known from the library 16, by inputting and storing the new profiles into the library, the library and the program of the present method becomes more knowledgeable and intelligent. Thus, the method of the present invention is a neural engine that can process with increasing intelligence the more it is used.

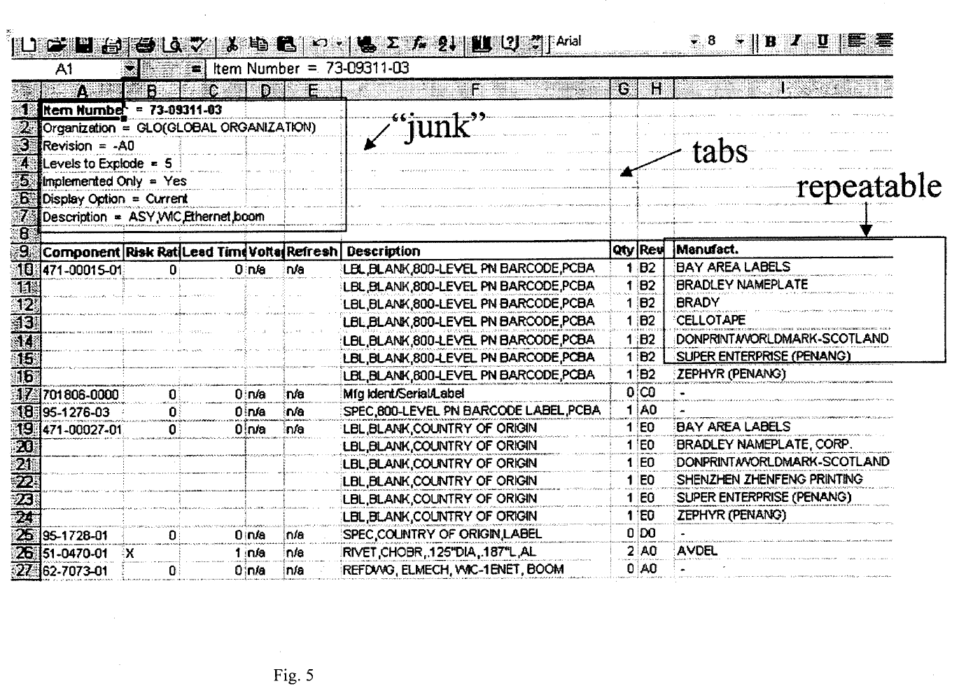

Assuming now that the recognition engine 18 is able to find a match between the header from the library 16 and the header 20 of the “converted” BOM file, the profile associated with the header that is a match is retrieved from the library 16 and is used to parse the “converted” BOM file at block 44. Referring to FIG. 5, there is shown an enlarged view of a portion of the BOM file shown in FIG. 3a. The profile of the BOM file shown in FIG. 5 would indicate to the parser that the junk 30 consists of information in a block consisting of columns A-E and Rows 1-8. Further, the header is contained in row 9, and the delimiter is a tab.

The parsing engine parses the “converted” BOM file based upon the profile from the library 16 and populates the data so extracted into a database, such as any of the well known databases, such as Oracle, Access, etc. As used herein, the term “database” merely refers to data in a defined pattern, such that queries and sorts can be performed. It can be stored in a Hard Disc Drive (HDD) or it can exist temporarily in the memory of a computer. The parsing engine 44 consists of two parts: an exceptions classes parser 45a, and a generic parser 45b. The exceptions classes parser 45a receives the exceptions from the library of profiles 16 depending upon the profile selected. For example, one exception might be to replace all non-breaking spaces (ASCII code 160) by white spaces (ASCII code 32).

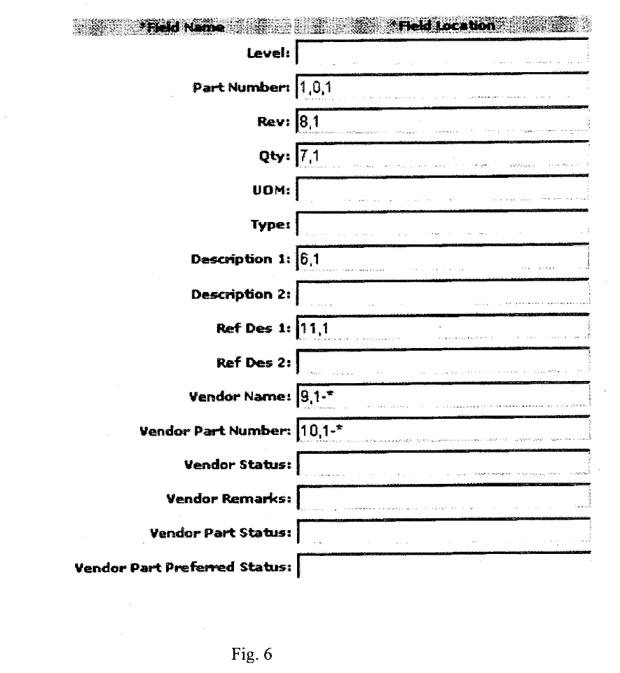

Referring to FIG. 6 there is shown an example of a portion of a profile to extract the “converted” BOM file shown in FIG. 5. In the entry designated “Rev:” shown in FIG. 6, the data is “8,1”. This indicates that the data for the “Rev” portion is found in column 8, and is in 1 row. Looking at FIG. 5, indeed one finds that the data for “Rev” is in column H or column 8, and is contained in one row. Similarly, the entry designated “Qty:” shown in FIG. 6 has the data of “7,1”. This indicates that the data for the “Qty” portion is found in column 7, and is in 1 row. Looking at FIG. 5, one finds that the data for “Qty” is in column G or column 7, and is contained in one row. As for the data for the “Part Number” which has the entry of “1,0,1”, the first “1” indicates that the data for the “Part Number” is found in column 1, or column A in FIG. 5. The “0” is the field or the amount of indent where the data begins. The final “1” indicates the number of rows. From the data shown in FIG. 6, the data from the “converted” BOM file is then extracted and placed into a database by block 46.

In the event the recognition engine 18 is unable to match the header from the library of profiles 16 with the header of the “converted” BOM file, the administrator must also input the profile information as exemplified by the data shown in FIG. 6. In addition, the administrator must enter the block information, i.e. the location of the boundaries for each block within a BOM file. Thus, the profile information consists of: header information; exceptions classes, if any; the location of data to be extracted, as exemplified by the table shown in FIG. 6; and the block information.

Once the data is placed in a database, it is “cleaned” if need be at block 48. By cleaning it is meant that certain unusual characters, such as apostrophe, semi-colon, dash, and space, are eliminated from the database. Thus, the program re-scans the data in the database to eliminate these characters.

Thereafter, the database is tested and validated in block 50. By testing and validation, it is meant that the database is tested so that it “makes sense”. For example, under the heading of “Qty” it is assumed that there must be a numerical entry. Further, the quantity cannot be an invalid amount, such as a very large number. Further, data for “Part Number” must be present. The absence of a “Part Number” data indicates an error. Other “common sense” or “reality checks” that can be tested include data entry for “Level”, “Description” and “Reference Designator”

Finally, in the event the result of testing validation of the database results in an error, then an error report is generated and the customer who generated the BOM file is notified at block 52.

The error report may also be used by the administrator to “correct” any of the profiles in the library 16.

It should be recognized that the present invention is not limited to the embodiment(s) described above and illustrated herein, but encompasses any and all variations falling within the scope of the appended claims.

What is claimed is:

1. A method of recognizing and normalizing repeatable data pattern from a file using a computer executing a computer program wherein said method comprising:
receiving said file;
recognizing the data pattern of said file based upon a profile selected from a plurality of profiles from a library;
parsing said file into a plurality of data fields based upon said profile selected; and
storing data from said data fields in a database.

2. The method of claim 1 further comprising:
checking said data stored in said database; and
notifying the detection of an error in the event said checking step results in an error.

3. The method of claim 1 further comprising:
notifying a user in the event said computer program is unable to recognize the data pattern of said file based upon any of said plurality of profiles from said library; and
manually inputting a new profile of said file into said library.

4. The method of claim 3 wherein said inputting step further comprising:
defining a plurality of blocks, wherein each block comprises repeatable data pattern.

5. The method of claim 1 wherein said file is a file of Bill of Materials or is a file of Approved Vendor List.

6. The method of claim 1 further comprising
converting said file into a text file in the event said file is not a text file prior to said parsing step.

7. A method of dynamically increasing the accuracy of recognizing and normalizing repeatable data pattern from a file using a computer executing a computer program wherein said method comprising:
receiving said file;
recognizing the data pattern of said file based upon a profile selected from a plurality of profiles from a library;
parsing said file into a plurality of data fields in the event said data pattern of said file is recognizable based upon said profile selected;
notifying a user in the event said computer program is unable to recognize the data pattern of said file based upon any of said plurality of profiles from said library; and
manually inputting a new profile of said file into said library.

8. The method of claim 7 further comprising:
checking said data stored in said database; and
notifying the detection of an error in the event said checking step results in an error.

9. The method of claim 7 wherein said inputting step further comprising:
defining a plurality of blocks, wherein each block comprises repeatable data pattern.

10. The method of claim 7 wherein said file is a file of Bill of Materials or is a file of Approved Vendor List.

11. The method of claim 7 further comprising
converting said file into a text file in the event said file is not a text file prior to said parsing step.

12. An article of manufacturing comprising:
a computer usable medium having computer readable program code embodied therein configured to recognize and normalize repeatable data pattern from a file, the computer readable program code in said article of manufacturing comprising:
computer readable program code configured to cause a computer to receive said file;
computer readable program code configured to cause a computer to recognize the data pattern of said file based upon a profile selected from a plurality of profiles from a library;
computer readable program code configured to cause a computer to parsing said file into a plurality of data fields based upon said profile selected; and
computer readable program code configured to cause a computer to store data from said data fields in a database.

13. The article of manufacture of claim 12 further comprising:
computer readable program code configured to cause a computer to check said data stored in said database; and
computer readable program code configured to cause a computer to notify the detection of an error in the event said computer program code in executing the checking step results in an error.

14. The article of manufacture of claim 12 further comprising:
computer readable program code configured to cause a computer to notify a user in the event said computer program is unable to recognize the data pattern of said file based upon any of said plurality of profiles from said library; and
computer readable program code configured to receive a new profile of said file manually inputted by a user to be added into said library.

15. The article of manufacture of claim 14 wherein said computer readable program code configured to receive a new profile further comprising:
computer readable program code configured to receive a plurality of user defined blocks, wherein each block comprises repeatable data pattern.

16. The article of manufacture of claim 12 wherein said file is a file of Bill of Materials or is a file of Approved Vendor List.

17. The article of manufacture of claim 12 further comprising
computer readable program code configured to convert said file into a text file in the event said file is not a text file prior to said parsing step.

18. An article of manufacturing comprising:
A computer usable medium having computer readable program code embodied therein configured to dynamically increase the accuracy of recognizing and normalizing repeatable data pattern from a file, the computer readable program code in said article of manufacturing comprising:
computer readable program code configured to cause a computer to receive said file;
computer readable program code configured to recognize the data pattern of said file based upon a profile selected from a plurality of profiles from a library;
computer readable program code configured to parse said file into a plurality of data fields in the event said data pattern of said file is recognizable based upon said profile selected;
computer readable program code configured to notify a user in the event said computer program is unable to recognize the data pattern of said file based upon any of said plurality of profiles from said library; and
computer readable program code configured to receive a new profile of said file into said library manually inputted by a user.

19. The article of manufacture of claim 18 further comprising:
computer readable program code configured to check said data stored in said database; and
computer readable program code configured to notify the detection of an error in the event said checking step results in an error.

20. The article of manufacture of claim 18 further comprising:
computer readable program code configured to receive a plurality of user defined blocks, wherein each block comprises repeatable data pattern.

21. The article of manufacture of claim 18 wherein said file is a file of Bill of Materials or is a file of Approved Vendor List.

22. The article of manufacture of claim 18 further comprising
computer readable program code configured to convert said file into a text file in the event said file is not a text file prior to said parsing step.

23. A computer system for recognizing and normalizing repeatable data from a file, said computer system comprising:
a computer;
said computer executing a computer program comprising:
computer readable program code configured to cause said computer to receive said file;
computer readable program code configured to cause said computer to recognize the data pattern of said file based upon a profile selected from a plurality of profiles from a library;
computer readable program code configured to cause said computer to parsing said file into a plurality of data fields based upon said profile selected; and
computer readable program code configured to cause said computer to store data from said data fields in a database.

24. The computer system of claim 23 further comprising:
said computer program further comprising:
computer readable program code configured to cause said computer to check said data stored in said database; and
computer readable program code configured to cause said computer to notify the detection of an error in the event said computer program code in executing the checking step results in an error.

25. The computer system of claim 23 further comprising:
computer readable program code configured to cause said computer to notify a user in the event said computer program is unable to recognize the data pattern of said file based upon any of said plurality of profiles from said library; and
computer readable program code configured to receive a new profile of said file manually inputted by a user to be added into said library.

26. The computer system of claim 25 wherein said computer readable program code configured to receive a new profile further comprising:
computer readable program code configured to receive a plurality of user defined blocks, wherein each block comprises repeatable data pattern.

27. The computer system of claim 23 wherein said file is a file of Bill of Materials or is a file of Approved Vendor List.

28. The computer system of claim 23 further comprising
computer readable program code configured to convert said file into a text file in the event said file is not a text file prior to said parsing step.

29. A computer system for dynamically increasing the accuracy of recognizing and normalizing repeatable data pattern from a file, said computer system comprising:
a computer;
said computer executing a computer program comprising:
computer readable program code configured to cause said computer to receive said file;
computer readable program code configured to recognize the data pattern of said file based upon a profile selected from a plurality of profiles from a library;
computer readable program code configured to parse said file into a plurality of data fields in the event said data pattern of said file is recognizable based upon said profile selected;
computer readable program code configured to notify a user in the event said computer program is unable to recognize the data pattern of said file based upon any of said plurality of profiles from said library; and
computer readable program code configured to receive a new profile of said file into said library manually inputted by a user.

30. The computer system of claim 29 further comprising:
computer readable program code configured to check said data stored in said database; and
computer readable program code configured to notify the detection of an error in the event said checking step results in an error.

31. The computer system of claim 29 further comprising:
computer readable program code configured to receive a plurality of user defined blocks, wherein each block comprises repeatable data pattern.

32. The computer system of claim 29 wherein said file is a file of Bill of Materials or is a file of Approved Vendor List.

33. The computer system of claim 29 further comprising
computer readable program code configured to convert said file into a text file in the event said file is not a text file prior to said parsing step.
